(19) United States
(12) Patent Application Publication
(10) Pub. No.: US 2025/0306497 A1
(43) Pub. Date: Oct. 2, 2025

(54) CHARGING DEVICE, IMAGE FORMING UNIT, AND IMAGE FORMING APPARATUS

(71) Applicant: FUJIFILM Business Innovation Corp., Tokyo (JP)

(72) Inventors: Yuki NAGAMORI, Kanagawa (JP); Tsutomu SUGIMOTO, Kanagawa (JP); Go MIURA, Kanagawa (JP)

(73) Assignee: FUJIFILM Business Innovation Corp., Tokyo (JP)

(21) Appl. No.: 18/817,263

(22) Filed: Aug. 28, 2024

(30) Foreign Application Priority Data
Mar. 27, 2024 (JP) 2024-052049

(51) Int. Cl. G03G 15/02; G03G 15/06

(52) U.S. Cl. CPC G03G 15/0291; G03G 15/065

(57) ABSTRACT

A charging device includes a discharge electrode; a control electrode that is disposed between the discharge electrode and a charged body charged by the discharge electrode, and is curved or bent along a surface shape of the charged body; a cleaning unit that cleans at least the control electrode of the discharge electrode and the control electrode; and a deformation unit that deforms a shape of the control electrode into different shapes between during cleaning and during charging by the cleaning unit.

### CROSS-REFERENCE TO RELATED APPLICATIONS

This application is based on and claims priority under 35 USC 119 from Japanese Patent Application No. 2024-052049 filed Mar. 27, 2024.

### BACKGROUND

### (i) Technical Field

The present invention relates to a charging device, an image forming unit, and an image forming apparatus.

### (ii) Related Art

In the related art, as techniques related to charging devices, for example, charging devices disclosed in JP2009-086091A, JP2019-045801A, and the like have already been proposed.

In JP2009-086091A, a control electrode is disposed in a shape along the curvature of a charged body such that a distance between the charged body and the control electrode does not vary depending on the location, and a surface of the control electrode on a side opposite to the charged body is cleaned by a cleaning member ([0022], [0028]).

JP2019-045801A discloses a configuration in which both surfaces of a control electrode formed in a planar shape can be cleaned by a cleaning member ([0056], [FIG. 4]).

### SUMMARY

Aspects of non-limiting embodiments of the present disclosure relate to a charging device, an image forming unit, and an image forming apparatus that improve cleanability of a control electrode while avoiding contact of the control electrode with a surface of a charged body, as compared with a case where the control electrode is cleaned in the same shape as a shape during charging.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a charging device that includes a discharge electrode; a control electrode that is disposed between the discharge electrode and a charged body charged by the discharge electrode, and is curved or bent along a surface shape of the charged body; a cleaning unit that cleans at least the control electrode of the discharge electrode and the control electrode; and a deformation unit that deforms a shape of the control electrode into different shapes between during cleaning and during charging by the cleaning unit.

### BRIEF DESCRIPTION OF THE DRAWINGS

Exemplary embodiment(s) of the present invention will be described in detail based on the following figures, wherein:

FIG. 1 is an overall configuration diagram illustrating an image forming apparatus to which a charging device according to a first exemplary embodiment of the present invention is applied;

FIG. 2 is a configuration diagram illustrating an image creating device of the image forming apparatus according to the first exemplary embodiment of the present invention;

FIG. 3 is a perspective configuration diagram illustrating an image forming unit according to the first exemplary embodiment of the present invention;

FIG. 4 is a perspective configuration diagram illustrating a unit body of the image forming unit according to the first exemplary embodiment of the present invention;

FIG. 5 is a perspective configuration diagram illustrating a grid electrode of a charging device according to the first exemplary embodiment of the present invention;

FIGS. 6A to 6C are configuration diagrams illustrating a controller of the grid electrode;

FIGS. 7A and 7B are configuration diagrams illustrating a connection portion of the grid electrode;

FIG. 8 is a perspective configuration diagram illustrating a charging device according to the first exemplary embodiment of the present invention;

FIG. 9 is a perspective configuration diagram illustrating an insulating block of a rear end of the charging device according to the first exemplary embodiment of the present invention;

FIG. 10 is a perspective configuration diagram illustrating an insulating block of a front end of the charging device according to the first exemplary embodiment of the present invention;

FIGS. 11A and 11B are configuration diagrams illustrating a tension member;

FIG. 12 is a sectional configuration diagram illustrating main parts of the insulating block of the front end;

FIG. 13 is a perspective configuration diagram illustrating a cleaning device;

FIG. 14 is a perspective configuration diagram illustrating the cleaning device;

FIG. 15 is a perspective configuration diagram illustrating the cleaning device;

FIG. 16 is a configuration diagram illustrating a swing arm;

FIG. 17 is a configuration diagram illustrating the swing arm;

FIG. 18 is a configuration diagram illustrating an operation of the tension member;

FIG. 19 is a perspective configuration diagram illustrating an action of the charging device according to the first exemplary embodiment of the present invention;

FIG. 20 is a configuration diagram illustrating a cleaning state of the grid electrode by the cleaning device;

FIG. 21 is a configuration diagram illustrating the cleaning state of the grid electrode by the cleaning device;

FIG. 22 is a perspective configuration diagram illustrating main parts of a charging device according to a second exemplary embodiment of the present invention;

FIG. 23 is a perspective configuration diagram illustrating a holding member;

FIG. 24 is a perspective configuration diagram illustrating an operation of the charging device according to the second exemplary embodiment of the present invention;

FIGS. 25A and 25B are front configuration diagrams illustrating an operation of a charging device according to a third exemplary embodiment of the present invention;

FIG. 26 is a configuration diagram illustrating an image creating device of an image forming apparatus according to a fourth exemplary embodiment of the present invention;

FIG. 27 is a schematic configuration diagram illustrating a modified example of the charging device;

FIGS. 28A to 28C are configuration diagrams illustrating a charging device according to the fourth exemplary embodiment of the present invention;

FIGS. 29A and 29B are configuration diagrams illustrating a modified example of the charging device according to the fourth exemplary embodiment of the present invention; and

FIGS. 30A and 30B are configuration diagrams illustrating a further modified example of the charging device according to the fourth exemplary embodiment of the present invention.

### DETAILED DESCRIPTION

Hereinafter, exemplary embodiments of the present invention will be described with reference to the drawings.

### First Exemplary Embodiment

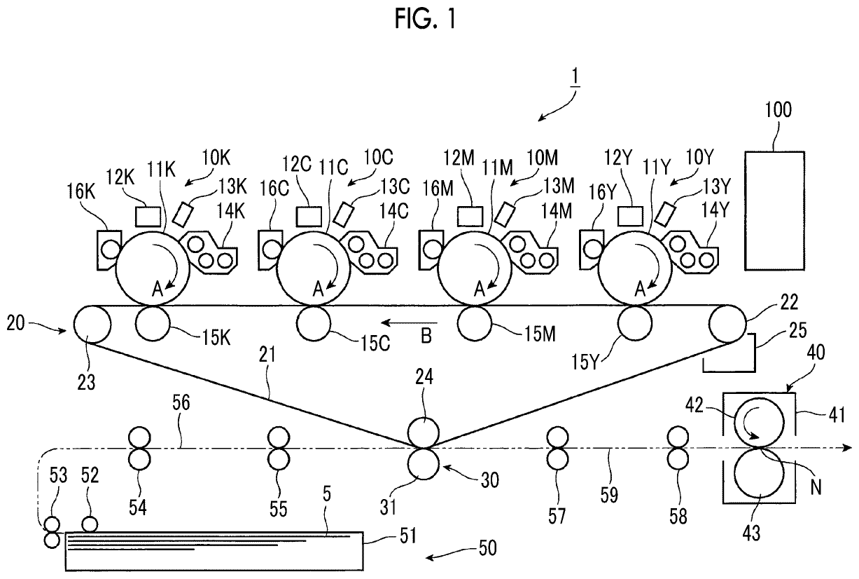

FIG. 1 is a configuration diagram illustrating the overall outline of an image forming apparatus to which a charging device and an image forming unit according to a first exemplary embodiment of the present invention are applied.

### Overall Configuration of Image Forming Apparatus

An image forming apparatus 1 according to the first exemplary embodiment is configured as, for example, a color printer. As illustrated in FIG. 1, the image forming apparatus 1 includes a plurality of image creating devices 10, an intermediate transfer device 20, a paper feeding device 50, a fixing device 40, and the like. The plurality of image creating devices 10 form toner images which are developed by toner constituting a developer. The intermediate transfer device 20 holds the toner image formed by each image creating device 10, and transports the toner image to a secondary transfer position where the toner image is secondarily transferred to a recording sheet 5, which is an example of a recording medium, in the end. The paper feeding device 50 accommodates and transports the required recording sheet 5 to be supplied to the secondary transfer position of the intermediate transfer device 20. The fixing device 40 fixes the toner image on the recording sheet 5 to which the toner image has been secondarily transferred by the intermediate transfer device 20. Note that a two-dot chain line in the drawing indicates a main transport path along which the recording sheet 5 is transported inside the image forming apparatus 1.

The image creating device 10 includes four image creating devices 10Y, 10M, 10C, and 10K that exclusively form toner images of four colors including yellow (Y), magenta (M), cyan (C), and black (K), respectively. The four image creating devices 10 (Y, M, C, K) are disposed in a row along the horizontal direction in an inner space of the image forming apparatus 1.

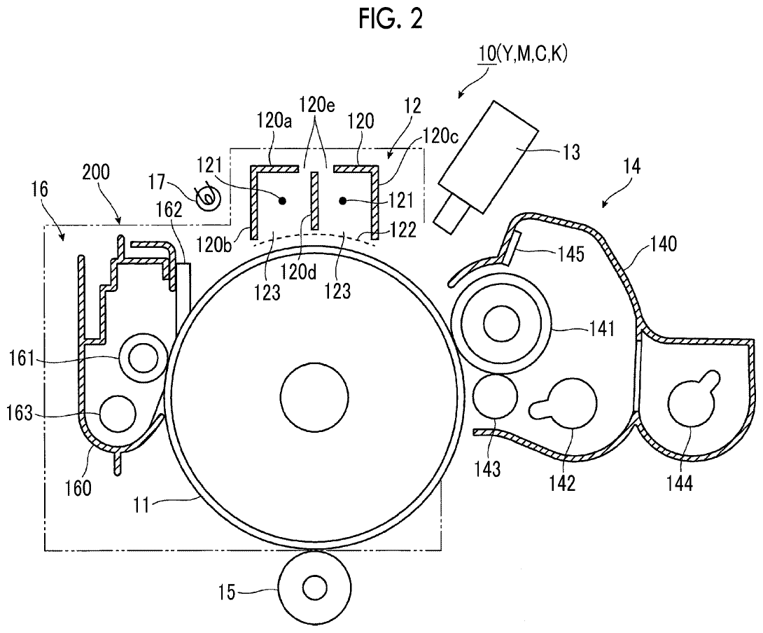

As illustrated in FIG. 2, each image creating device 10 (Y, M, C, K) includes a rotating photosensitive drum 11 as an example of a charged body and an image holding unit. Around the photosensitive drum 11, there are a charging device 12 (Y, M, C, K) as an example of a charging unit according to the first exemplary embodiment, an exposure device 13 (Y, M, C, K) as an example of an electrostatic latent image forming unit, a developing device 14 (Y, M, C, K), a primary transfer device 15 (Y, M, C, K), a drum cleaning device 16 (Y, M, C, K), and the like. The charging device 12 charges a peripheral surface (an image holding surface) of the photosensitive drum 11, on which an image can be formed, to a required potential. The exposure device 13 irradiates the charged peripheral surface of the photosensitive drum 11 with light based on image information (a signal) to form an electrostatic latent image with a potential difference (for each color). The developing device 14 develops the electrostatic latent image with toner of the developer of the corresponding color (Y, M, C, K) to obtain a toner image. The primary transfer device 15 transfers each toner image to the intermediate transfer device 20. The drum cleaning device 16 removes and cleans adhesive substances, such as toner, remaining on and adhering to the image holding surface of the photosensitive drum 11 after the primary transfer.

The photosensitive drum 11 is obtained by forming, on a peripheral surface of a cylindrical or columnar base material to be grounded, an image holding surface including a photoconductive layer (a photosensitive layer) consisting of a photosensitive material. The base material of the photosensitive drum 11 is grounded. The photosensitive drum 11 is supported to rotate in a direction indicated by arrow A, as an example of a movement direction, by receiving a driving force transmitted from a drive unit (not illustrated). As illustrated in FIG. 2, the surface shape of the photosensitive drum 11 is curved in a circular shape having a required curvature radius about a rotation axis.

The charging device 12 is configured by a so-called scorotoron charger that is disposed in a state of being separated from the photosensitive drum 11. The scorotoron charging device 12 has a higher charging ability for the photosensitive drum 11 as compared with a charging roll having a roll shape. Therefore, the scorotoron charging device 12 is particularly effective in the high-productivity image forming apparatus 1, in which a rotation speed of the photosensitive drum 11, which determines a process speed, is increased. A charging voltage and a control voltage are supplied to the charging device 12. As the charging voltage, in a case where the developing device 14 performs reverse development, a voltage or current having the same polarity as the charging polarity of the toner supplied from the developing device 14 is supplied. Note that the configuration of the charging device will be described in detail later.

The exposure device 13 consists of a light emitting diode (LED) printhead that irradiates the photosensitive drum 11 with light according to the image information by LEDs serving as a plurality of light emitting elements arranged along an axial direction of the photosensitive drum 11 to form an electrostatic latent image. Note that, as the exposure device 13, a device that performs deflection and scanning along the axial direction of the photosensitive drum 11 with laser light configured according to the image information may be used.

As illustrated in FIG. 2, any developing device 14 (Y, M, C, K) is configured by disposing a developing roll 141, an agitation supply member 142, a developer supply roll 143, an agitation transport member 144, a layer thickness regulation member 145, and the like in a housing 140. Inside the housing 140, an opening portion at a position facing the photosensitive drum 11 and an accommodation chamber for a developer are formed. The developing roll 141 holds a developer, and transports the developer to a development region that faces the photosensitive drum 11. The agitation supply member 142 consists of a screw auger or the like that supplies the developer such that the developer passes through the developing roll 141 while agitating the developer. The developer supply roll 143 supplies the developer supplied from the agitation supply member 142 to the developing roll 141. The agitation transport member 144 consists of a screw auger or the like that transports the developer to the agitation supply member 142 while agitating the developer. The layer thickness regulation member 145 regulates the amount (layer thickness) of the developer held on the developing roll 141. In the developing device 14, a developing voltage is supplied from a power supply device (not illustrated) to a portion between the developing roll 141 and the photosensitive drum 11. For example, a two-component developer containing a non-magnetic toner and a magnetic carrier is used as the developers of four colors.

The primary transfer device 15 (Y, M, C, K) is a contact-type transfer device including a primary transfer roll that rotates around the photosensitive drum 11 in contact with the photosensitive drum 11 via an intermediate transfer belt 21 and that is supplied with a primary transfer voltage. As the primary transfer voltage, a direct-current voltage having a polarity opposite to the charging polarity of the toner is supplied from the power supply device (not illustrated).

The drum cleaning device 16 is configured by a body 160, a cleaning brush 161, a cleaning plate 162, a sending member 163, and the like. The body 160 is formed in a container shape of which a portion is open. The cleaning brush 161 is disposed to be in contact with the peripheral surface of the photosensitive drum 11 after the primary transfer with a required pressure, and performs cleaning by scraping off the adhesive substances such as residual toner. The cleaning plate 162 is disposed to be in contact with the peripheral surface of the photosensitive drum 11 with a required pressure, and performs cleaning by removing the adhesive substances such as residual toner. The sending member 163 consists of a screw auger or the like that transports the adhesive substances such that the adhesive substances such as the toner removed by the cleaning brush 161 and the cleaning plate 162 are collected and the adhesive substances are sent to a collection system (not illustrated). As the cleaning plate 162, a plate-shaped member (for example, a blade) consisting of a material such as rubber is used.

A charge erasing lamp 17 is disposed between the drum cleaning device 16 and the charging device 12. The charge erasing lamp 17 erases the charge by uniformly exposing the surface of the photosensitive drum 11 from which the adhesive substances such as residual toner have been removed by the drum cleaning device 16.

As illustrated in FIG. 1, the intermediate transfer device 20 is disposed to be at a position below each image creating device 10 (Y, M, C, K) along a vertical direction. The intermediate transfer device 20 is mainly configured by an intermediate transfer belt 21, a plurality of belt support rolls 22 to 24, a secondary transfer device 30, and a belt cleaning device 25. The intermediate transfer belt 21 rotates in a direction indicated by arrow B while passing through a primary transfer position between the photosensitive drum 11 and the primary transfer device 15 (primary transfer roll). The plurality of belt support rolls 22 to 24 rotatably support the intermediate transfer belt 21 by holding the intermediate transfer belt 21 from the inner surface thereof in a desired state. The secondary transfer device 30 is disposed on an outer peripheral surface (image holding surface) side of the intermediate transfer belt 21 supported by the belt support roll 24, and secondarily transfers a toner image on the intermediate transfer belt 21 to the recording sheet 5. The belt cleaning device 25 performs cleaning by removing the adhesive substances such as toner and paper dust, which remain and adhere to the outer peripheral surface of the intermediate transfer belt 21 after passing through the secondary transfer device 30.

For example, an endless belt made of a material, in which a resistance adjusting agent such as carbon black is dispersed in a synthetic resin such as a polyimide resin and a polyamide resin, is used as the intermediate transfer belt 21. In addition, the belt support roll 22 is configured as a drive roll that is rotationally driven by a drive device (not illustrated). The belt support roll 23 is configured as a surface leveling roll that holds an image forming surface of the intermediate transfer belt 21. The belt support roll 24 is configured as a facing roll that faces the secondary transfer device 30. The belt support roll 22 also functions as a support roll that supports a back surface of the belt cleaning device 25.

As illustrated in FIG. 1, the secondary transfer device 30 is a contact-type transfer device including a secondary transfer roll 31. The secondary transfer roll 31 rotates in contact with the peripheral surface of the intermediate transfer belt 21 and is supplied with a secondary transfer voltage, at the secondary transfer position that is an outer peripheral surface portion of the intermediate transfer belt 21, which is supported by the belt support roll 24, in the intermediate transfer device 20. In addition, as the secondary transfer voltage, a direct-current voltage having the opposite polarity or the same polarity as the charging polarity of the toner is supplied from the power supply device (not illustrated) to the secondary transfer roll 31 or the belt support roll 24 of the intermediate transfer device 20.

The fixing device 40 is configured by disposing a heating rotor 42, a pressurizing rotor 43, and the like in a housing 41. An introduction port and a discharge port for the recording sheet 5 are formed in the housing 41. The heating rotor 42 is formed in a belt form or a roll form that rotates in a direction indicated by an arrow and is heated by a heating unit such that the surface temperature is maintained at a predetermined temperature. The pressurizing rotor 43 is formed in a roll form or a belt form that is in contact with the heating rotor 42 at a predetermined pressure in a state of being substantially along the axial direction of the heating rotor 42 and that is driven to rotate. In the fixing device 40, a contact portion where the heating rotor 42 and the pressurizing rotor 43 are in contact with each other is a fixing nip portion N where required fixing processing (heating and pressurization) is performed.

The paper feeding device 50 is disposed to be present at a position below the intermediate transfer device 20. The paper feeding device 50 is mainly configured by a single (or a plurality of) sheet accommodation body 51 and sending devices 52 and 53. The sheet accommodation body 51 accommodates the recording sheet 5 having a desired size, type, and the like in a loaded state. The sending devices 52 and 53 send the recording sheet 5 one by one from the sheet accommodation body 51. The sheet accommodation body 51 is provided, for example, to be able to be pulled out to the front surface (side surface that the user faces at the time of operating the apparatus) side of the apparatus body.

Examples of the recording sheet 5 include thin paper such as plain paper and tracing paper, OHP sheets, and the like, which are used in electrophotographic copying machines and printers. In order to further improve the smoothness of an image surface after fixing, for example, it is preferable that the surface of the recording sheet 5 is as smooth as possible. For example, coated paper in which the surface of plain paper is coated with resin or the like, so-called thick paper such as art paper for printing, or the like having a relatively large basis weight can also be suitably used.

A plurality of or single sheet transport roll pairs 54 and 55 and a paper feed transport path 56 are provided between the paper feeding device 50 and the secondary transfer device 30. The sheet transport roll pairs 54 and 55 transport the recording sheet 5 sent from the paper feeding device 50 to the secondary transfer position. The paper feed transport path 56 is configured by a transport guide (not illustrated). The sheet transport roll pair 55 disposed at a position immediately before the secondary transfer position in the paper feed transport path 56 is configured as, for example, a roll (registration roll) that adjusts the transport timing of the recording sheet 5. In addition, a plurality of or single sheet transport roll pairs 57 and 58 and a sheet transport path 59, which are for transporting the recording sheet 5 after the secondary transfer sent from the secondary transfer device 30 to the fixing device 40, are provided between the secondary transfer device 30 and the fixing device 40. Note that a sheet discharge unit (not illustrated) that discharges the recording sheet 5 after fixing, which is sent from the fixing device 40, is provided on a side surface of the image forming apparatus 1.

Note that the image forming apparatus 1 may include a duplex sheet transport path (not illustrated) for forming an image on both sides of the recording sheet 5.

Reference sign 100 in FIG. 1 indicates a control device that comprehensively controls the operation of the image forming apparatus 1. The control device 100 includes a central processing unit (CPU), a read only memory (ROM), a random access memory (RAM), a bus that connects the CPU, the ROM, and the like to each other, a communication interface, and the like (not illustrated).

### Configuration of Image Forming Unit

As illustrated in FIG. 2, the image forming apparatus 1 according to the first exemplary embodiment includes a plurality of image forming units 200 corresponding to the respective image creating devices 10 (Y, M, C, K) in order to improve maintainability and the like. Each image forming unit 200 is configured by integrating a plurality of members, including at least the photosensitive drum 11, into a unit, among the members constituting the respective image creating devices 10 (Y, M, C, K) of yellow (Y), magenta (M), cyan (C), and black (K). The respective image forming units 200 are individually attachable to and detachable from the image forming apparatus 1.

In the first exemplary embodiment, as illustrated in FIG. 2, the photosensitive drum 11, the charging device 12, and the drum cleaning device 16 are integrally configured as the image forming unit 200. Note that the charging device 12 may be configured to be attachable to and detachable from the photosensitive drum 11 and the drum cleaning device 16 independently. The image forming unit 200 is replaced with a new one in a case where a member such as the photosensitive drum 11 reaches the end of the life of the member or in a case where a failure occurs in the charging device 12 or the drum cleaning device 16. In a case where the image forming unit 200 does not include the developing device 14, the common image forming unit 200 can be used corresponding to all the image creating devices 10 (Y, M, C, K).

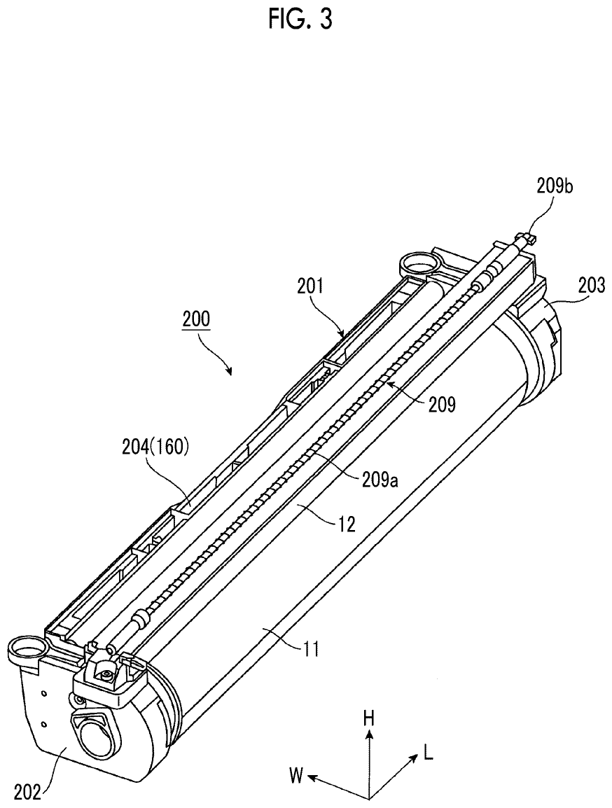

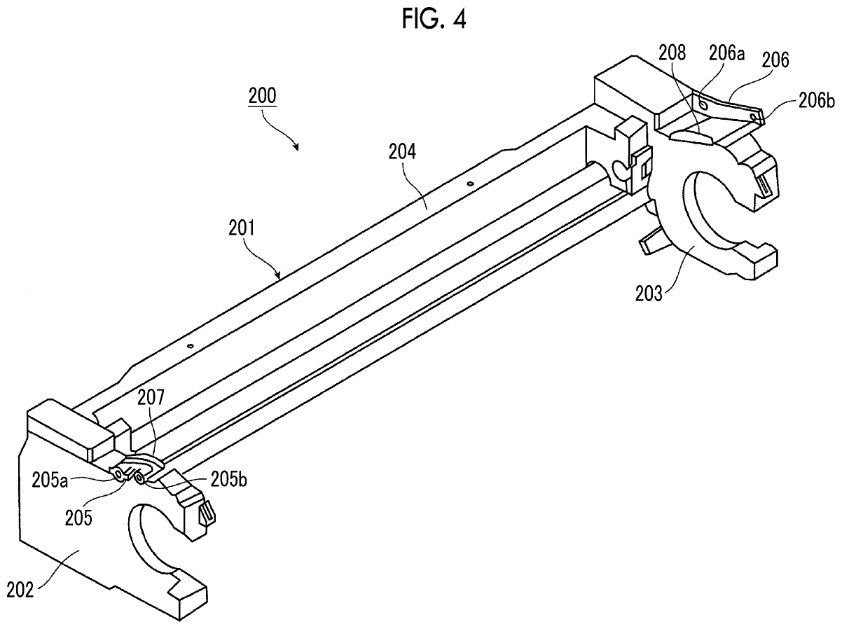

As illustrated in FIG. 3, the image forming unit 200 includes a unit body 201. The unit body 201 includes front and rear support portions 202 and 203 that rotatably support both end portions along the axial direction of the photosensitive drum 11, and a connection portion 204 that connects the front and rear support portions 202 and 203 on one side surface of the photosensitive drum 11. As illustrated in FIG. 4, the front and rear support portions 202 and 203 are provided with front and rear positioning portions 205 and 206 that position both end portions along a longitudinal direction of the charging device 12. In the front and rear positioning portions 205 and 206, positioning holes 205a and 205b and positioning holes 206a and 206b for positioning the charging device 12 are respectively open.

In the front and rear support portions 202 and 203 of the unit body 201, curved portions 207 and 208 are provided for supporting a grid electrode 122 of the charging device 12 in a curved shape conforming to the surface shape of the photosensitive drum 11 in a case where the charging device 12 is mounted. The curved portions 207 and 208 are formed in an arc shape that protrudes by a required distance with respect to the surface of the photosensitive drum 11 mounted to be rotatable in the image forming unit 200. The height of the curved portions 207 and 208 determines a gap (DGS) between the surface of the photosensitive drum 11 and the grid electrode 122 of the charging device 12.

In addition, the connection portion 204 of the unit body 201 also serves as the body 160 of the drum cleaning device 16. Note that a drive shaft 209 that drives a cleaning device 70 to be described later, which cleans the charging device 12, along the axial direction of the photosensitive drum 11 is rotatably attached to an upper portion of the charging device 12. Helical convex portions 209a are provided at a large pitch on the outer peripheral surface of the drive shaft 209. An adapter portion 209b to which a driving force is transmitted from the image forming apparatus 1 in a case where the image forming unit 200 is mounted on the image forming apparatus 1 is provided at an end portion on the inner side along the axial direction of the drive shaft 209.

The image forming unit 200 is configured to be insertable and drawable along a depth direction intersecting a width direction of the image forming apparatus 1 from an opening portion provided on a front surface of an apparatus body (not illustrated) of the image forming apparatus 1 in a state where a front cover (not illustrated) of the image forming apparatus 1 is opened.

### Operation of Image Forming Apparatus

Hereinafter, a basic image forming operation by the image forming apparatus 1 will be described.

Here, the operation in a full-color mode in which a full-color image configured by combining toner images of four colors (Y, M, C, K) is formed using the four image creating devices 10 (Y, M, C, K) will be described.

In a case where the image forming apparatus 1 receives image information and request command information for a full-color image forming operation (print) from a personal computer, an image reading device, or the like (not illustrated), the control device 100 starts the four image creating devices 10 (Y, M, C, K), the intermediate transfer device 20, the secondary transfer device 30, the fixing device 40, and the like.

Then, in each image creating device 10 (Y, M, C, K), as illustrated in FIG. 1, each photosensitive drum 11 is first rotated in the direction indicated by the arrow A, and each charging device 12 charges the surface of each photosensitive drum 11 to a required polarity (negative polarity in the first exemplary embodiment) and a required potential.

Subsequently, the exposure device 13 irradiates the surface of the photosensitive drum 11 after charging with light emitted on the basis of the signal of the image obtained by the conversion into each color component (Y, M, C, K), and forms the electrostatic latent image of each color component having a required potential difference on the surface of the photosensitive drum 11.

Next, each developing device 14 (Y, M, C, K) develops the electrostatic latent image of each color component formed on the photosensitive drum 11 by supplying toner of the corresponding color (Y, M, C, K) charged to the required polarity (negative polarity) from the developing roll 141 and causing the toner to electrostatically adhere to the electrostatic latent image. Through such development, the electrostatic latent image of each color component formed on each photosensitive drum 11 is visualized as the toner image of four colors (Y, M, C, K) developed with the toner of the corresponding color.

Next, in a case where the toner image of each color formed on the photosensitive drum 11 of each image creating device 10 (Y, M, C, K) is transported to the primary transfer position, each primary transfer device 15 (Y, M, C, K) primarily transfers the toner image of each color in a state where the toner images of the respective colors are superimposed in order on the intermediate transfer belt 21 rotating in a direction indicated by an arrow B of the intermediate transfer device 20.

In addition, in each image creating device 10 (Y, M, C, K) in which the primary transfer is ended, the drum cleaning device 16 cleans the surface of the photosensitive drum 11 by removing the adhesive substances such that the adhesive substances are scraped off. Accordingly, each image creating device 10 (Y, M, C, K) is brought into a state where the next image creation operation can be performed.

Next, in the intermediate transfer device 20, the toner images that are primarily transferred are held and transported to the secondary transfer position by the rotation of the intermediate transfer belt 21. On the other hand, in the paper feeding device 50, the required recording sheet 5 is sent to the paper feed transport path 56 in accordance with the image creation operation. In the paper feed transport path 56, the sheet transport roll pair 55 as the registration roll sends out and supplies the recording sheet 5 to the secondary transfer position in accordance with the transfer timing.

At the secondary transfer position, the secondary transfer device 30 collectively secondarily transfers the toner images on the intermediate transfer belt 21 to the recording sheet 5. In addition, in the intermediate transfer device 20 in which the secondary transfer is ended, the belt cleaning device 25 performs cleaning by removing the adhesive substances such as toner remaining on the surface of the intermediate transfer belt 21 after the secondary transfer. Subsequently, the recording sheet 5 on which the toner image is secondarily transferred is peeled off from the intermediate transfer belt 21 and then is transported to the fixing device 40 via the sheet transport path 59. In the fixing device 40, the recording sheet 5 after the secondary transfer is introduced into and passes through the contact portion between the rotating heating rotor 42 and the pressurizing rotor 43, and thus necessary fixing processing (heating and pressurization) is performed to fix an unfixed toner image to the recording sheet 5. Finally, the recording sheet 5 after the fixing is completed is discharged to the sheet discharge unit provided on the side surface of the apparatus body (not illustrated), for example.

By the above operation, the recording sheet 5 on which the full-color image configured by combining the toner images of four colors is formed is output.

### Configuration of Charging Device

As illustrated in FIGS. 2 and 3, the charging device 12 according to the first exemplary embodiment is disposed along the axial direction of the photosensitive drum 11, which is an example of a direction intersecting a rotation direction A of the photosensitive drum 11. Here, the axial direction of the photosensitive drum 11 is the longitudinal direction of the charging device 12. In FIG. 3, reference symbol L indicates the longitudinal direction of the charging device 12, reference symbol W indicates the width direction of the charging device 12, and reference symbol H indicates a height direction of the charging device 12.

Note that, in FIG. 3, a case where the charging device 12 is disposed directly above the photosensitive drum 11 is illustrated, and the height direction H of the charging device 12 matches the vertical direction. However, the charging device 12 is not limited to being disposed directly above the photosensitive drum 11, and may be disposed at an oblique position along a circumferential direction of the photosensitive drum 11. In this case, the height direction H of the charging device 12 is a direction different from the vertical direction.

As illustrated in FIG. 2, the charging device 12 includes, broadly, a shield case 120 as an example of a housing, a single or a plurality of (two in the illustrated example) discharge wires 121 and 121 as an example of a discharge electrode, and the grid electrode 122 as an example of the control electrode.

The shield case 120 consists of metal such as stainless steel or aluminum. The shield case 120 functions as a counter electrode in a case where a high voltage is applied to the discharge wires 121 and 121 to generate a corona discharge. The shield case 120 is formed in a rectangular parallelepiped shape that has an opening portion 123 where the entire surface of the surface (lower surface in the drawing) facing the photosensitive drum 11 is open and that is elongated along the axial direction of the photosensitive drum 11. The shield case 120 includes a ceiling wall 120a, left and right side walls 120b and 120c, and a partition wall 120d. The ceiling wall 120a is positioned at an upper end portion on a side opposite to the photosensitive drum 11. The left and right side walls 120b and 120c are provided in a state of being bent downward to face the photosensitive drum 11 from both ends along the width direction of the ceiling wall 120a. The partition wall 120d partitions a space in the shield case 120 along the width direction as the rotation direction A of the photosensitive drum 11, according to the number of discharge wires 121 and 121. Note that, in a case where there is one discharge wire 121, the partition wall 120d is not provided. In a case where the number of discharge wires 121 is three or more, the partition walls 120d that partition the space between the discharge wires 121, 121, and the like are provided. Note that the shield case 120 is applied with the same high voltage as the grid electrode 122 or is grounded. The cylindrical or columnar conductive base of the photosensitive drum 11 is grounded.

A blowing port 120e that blows air into the shield case 120 is opened in the ceiling wall 120a of the shield case 120 over the entire length along the longitudinal direction at the center along the width direction. The blowing port 120e blows air toward the surface of the photosensitive drum 11 to remove discharge products such as ozone generated by the corona discharge.

The discharge wires 121 and 121 consist of tungsten, carbon tungsten, tungsten subjected to gold plating, or the like. For example, a negative polarity of a high voltage of several K to about 8 KV is applied to the discharge wires 121 and 121 by a high-voltage power source (not illustrated).

The grid electrode 122 is disposed in the opening portion 123 of the shield case 120 facing the photosensitive drum 11, in a state of being curved in an arc shape along the surface shape of the photosensitive drum 11. For example, a high voltage substantially equal to the desired potential is applied to the grid electrode 122 by a high-voltage power source (not illustrated) in order to obtain the desired charging potential of the photosensitive drum 11.

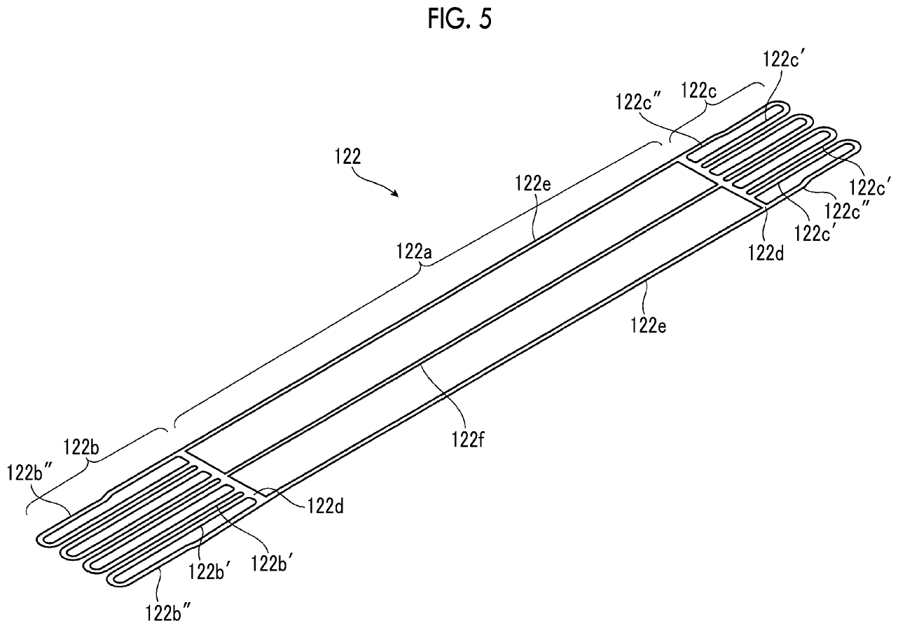

For example, as illustrated in FIG. 5, the grid electrode 122 is formed in a flat plate shape having an elongated rectangular plane corresponding to the opening portion 123 of the shield case 120 by performing an etching treatment, press working, or the like on a thin plate-shaped member consisting of metal such as tungsten, carbon tungsten, or tungsten subjected to gold plating. The grid electrode 122 integrally includes a controller 122a and connection portions 122b and 122c. The controller 122a is provided over the entire region excluding both end portions of the grid electrode 122 along the longitudinal direction. The connection portions 122b and 122c are respectively provided at both end portions of the controller 122a along the longitudinal direction. A boundary portion 122d formed in a short band shape along the longitudinal direction is provided between the controller 122a and each of the connection portions 122b and 122c. The controller 122a of the grid electrode 122 has slightly wider band-shaped edge portions 122e and 122e at both end portions along the width direction. In addition, the controller 122a is divided by a band-shaped division portion 122f having a narrower width than the edge portions 122e and 122e, at the center along the width direction. Note that the division portion 122f does not necessarily have to be provided.

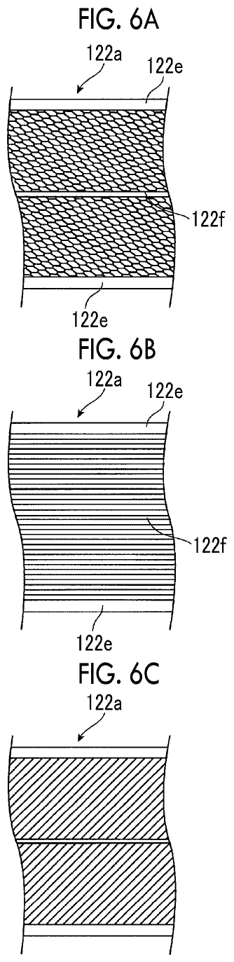

As illustrated in FIGS. 6A to 6C, as the controller 122a of the grid electrode 122, a controller in which fine mesh-like conductors or linear conductors having a narrow width along the longitudinal direction are arranged in parallel with each other along the width direction, or a controller in which linear conductors that are inclined along a direction intersecting the longitudinal direction and have a narrow width are arranged in parallel with each other and fine gaps are uniformly formed along the longitudinal direction and the width direction is used.

The controller 122a of the grid electrode 122 charges the photosensitive drum 11 by causing charged particles such as ions generated by corona discharge, which is generated by applying a high voltage to the discharge wires 121 and 121, to adhere to the surface of the photosensitive drum 11 via gaps formed between mesh-like conductors or linear conductors having a narrow width, and controls the charging potential of the photosensitive drum 11 by the action of the electric field formed by the voltage applied to the controller 122a.

As illustrated in FIG. 5, the connection portions 122b and 122c of the grid electrode 122 have an even number (eight in the illustrated example) of linear thin connection pieces 122b′ and 122c′ that extend in parallel with each other from both end portions along the longitudinal direction of the controller 122a via the boundary portion 122d to the distal end along the longitudinal direction. The connection portions 122b and 122c are configured such that the distal ends of two adjacent connection pieces 122b′ and 122c′ are connected to each other in a loop shape by using the adjacent connection pieces 122b′ and 122c′ as one set. In the illustrated example, the connection pieces 122b″ and 122c″ positioned at both end portions along the width direction are curved from the middle along the longitudinal direction toward the inside in the width direction.

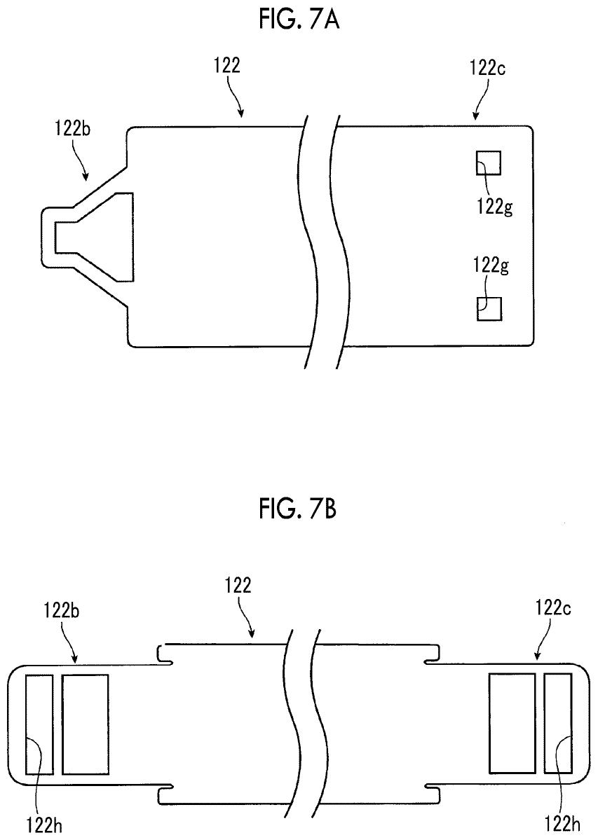

Note that, as the connection portions 122b and 122c of the grid electrode 122, as illustrated in FIG. 7A, connection portions in which two connection portions 122b and 122b inclined from both end sides along the width direction toward the center of the distal end along the longitudinal direction extend respectively, the distal ends of the two connection portions 122b and 122b are connected in a U-shape, and opening portions 122g are provided for engaging a locking claw (not illustrated), or connection portions which extend in a band shape having a wide width, toward the distal end along the longitudinal direction and are provided with elongated opening portions 122h and 122h for the connection along the width direction at the distal end as illustrated in FIG. 7B may be used.

However, as illustrated in FIG. 5, in a case where, as the connection portions 122b and 122c of the grid electrode 122, the connection portions in which the distal ends of the connection pieces 122b′ and 122c′ provided in an even number to be in parallel with each other along the width direction are connected in a loop shape are used, for example, it is possible to apply tension substantially uniformly along the width direction of the grid electrode 122, which is desirable.

As illustrated in FIG. 5, the grid electrode 122 has a flat plate shape as the free shape in a case where no tension is applied along the longitudinal direction. Therefore, the grid electrode 122 becomes a flat plate shape as the free shape, by the elastic restoring force of the grid electrode 122 in a case where the tension is released or reduced.

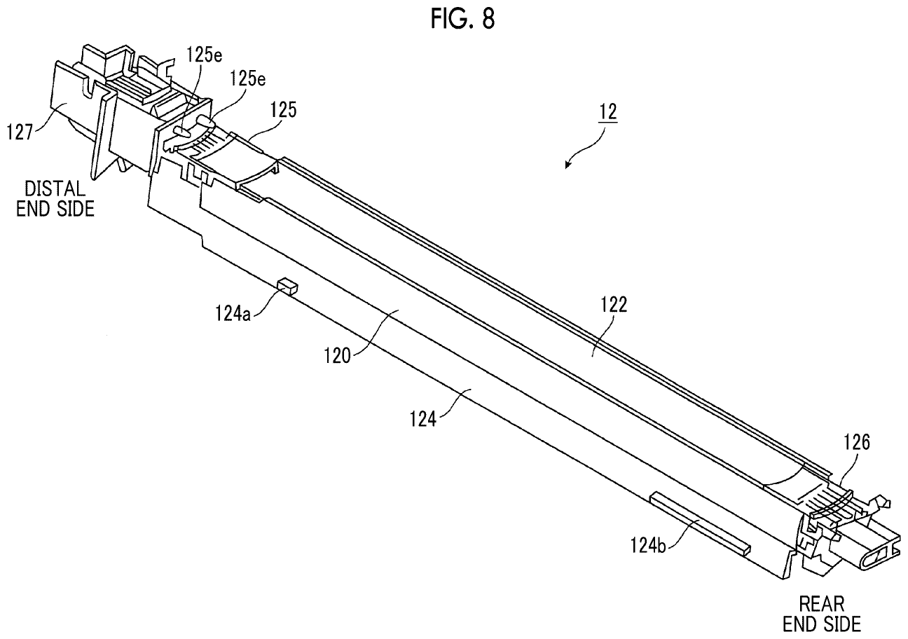

The configuration of the charging device 12 will be further described. As illustrated in FIG. 8, the charging device 12 includes a guide member 124, front-end and rear-end insulating blocks 125 and 126, and a mounting member 127. The guide member 124 is provided on the surface (lower surface in the drawing) of the shield case 120 on a side opposite to the photosensitive drum 11, along the longitudinal direction. The front-end and rear-end insulating blocks 125 and 126 are respectively disposed at both ends of the shield case 120 along the longitudinal direction. The mounting member 127 is provided at an end portion on the front surface side of the front-end insulating block 125 disposed on the front side of the image forming apparatus 1.

The guide member 124 is formed in an elongated flat plate shape with a synthetic resin or the like. On an outer surface of the guide member 124, two guide convex portions 124a and 124b for guiding the charging device 12 in a case of mounting the charging device 12 on the image forming apparatus 1 are provided at both end portions along the longitudinal direction. The two guide convex portions 124a and 124b are formed such that the guide convex portion 124b disposed on the back surface side of the image forming apparatus 1 is longer than the guide convex portion 124a disposed on the front surface side of the image forming apparatus 1.

The front-end and rear-end insulating blocks 125 and 126 consist of one or a plurality of insulating members made of synthetic resin. The insulating blocks 125 and 126 are respectively fixed to both end portions of the shield case 120 along the longitudinal direction by means of snap engagement or the like. The two discharge wires 121 and 121 and the grid electrode 122 are tensioned on the front-end and rear-end insulating blocks 125 and 126. One end of each of the discharge wires 121 and 121 is fixed to one insulating block 126 of the front-end and rear-end insulating blocks 125 and 126, and the other end thereof is fixed to the other insulating block 125 by applying a required tension thereto via an elastic member such as a coil spring.

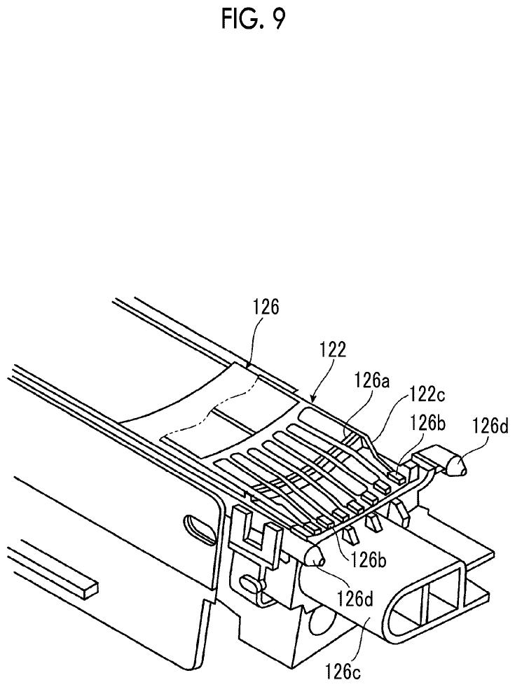

As illustrated in FIG. 9, the rear-end insulating block 126 is provided with a curved-shaped holding portion 126a that holds the rear end portion of the grid electrode 122 by deforming the rear end portion into a curved shape conforming to the surface shape of the photosensitive drum 11, and a plurality of locking claws 126b, 126b, and the like that fix the connection portion 122c of the grid electrode 122 in a locked state. In addition, a semi-cylindrical and square tubular conductive portion 126c including a plurality of current supply electrodes (not illustrated) for applying current to each of the shield case 120, the discharge wire 121, and the grid electrode 122 is provided at the distal end of the rear-end insulating block 126. The conductive portion 126c of the rear-end insulating block 126 is connected to an electrode on the image forming apparatus 1 side in a case where the charging device 12 is mounted on the image forming apparatus 1, and thereby enables current to flow through the shield case 120, the discharge wire 121 and the grid electrode 122.

The rear-end insulating block 126 is provided with positioning pins 126d and 126d at both end portions along the width direction, and the positioning pins 126d and 126d, which position the rear end portion of the charging device 12 in a case where the charging device 12 is mounted on the image forming apparatus 1, protrude toward the inner side along the longitudinal direction. As illustrated in FIG. 4, the positioning pins 126d and 126d of the rear-end insulating block 126 are fitted into the positioning holes 206a and 206b of the positioning portion 206 provided in the support portion 203 of the rear end of the image forming unit 200, thereby performing the positioning of the charging device 12.

As illustrated in FIG. 10, the front-end insulating block 125 is provided with a curved-shaped holding portion 125a that holds the front end portion of the grid electrode 122 by deforming the front end portion into a curved shape conforming to the surface shape of the photosensitive drum 11, and a tension member 60 that tensions the connection portion 122b of the grid electrode 122 in a state where the connection portion 122b is locked. The tension member 60 applies tension by displacing the connection portion 122b of the grid electrode 122 outward with respect to a charging region of the grid electrode 122 to tension the connection portion 122b. The tension member 60 is attached to the front-end insulating block 125 to be rotatable about the rotation axis disposed along a width direction W of the charging device 12.

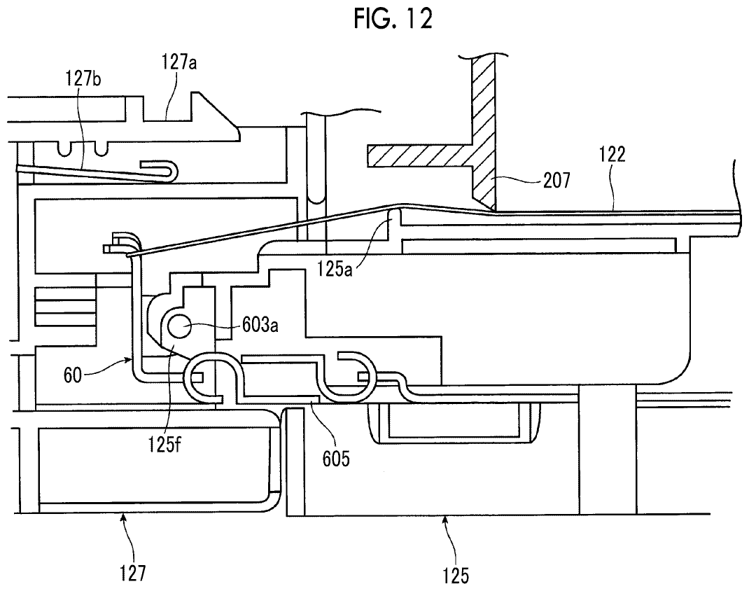

As illustrated in FIG. 12, the holding portions 125a and 126a of the insulating blocks 125 and 126 and the curved portions 207 and 208 of the image forming unit 200 are disposed to slightly protrude to the opposite member side with respect to the tension position of the grid electrode 122. As a result, the shape and position of the grid electrode 122 are defined by the curved portions 207 and 208 of the image forming unit 200.

As illustrated in FIG. 10, a standing wall 125d in which an insertion hole 125c through which the connection portion 122b of the grid electrode 122 is inserted is opened is provided in the front-end insulating block 125. In addition, on the standing wall 125d of the insulating block 125, positioning pins 125e and 125e (refer to FIG. 8) for positioning the front end portion of the charging device 12 in a case where the charging device 12 is mounted on the image forming apparatus 1 are provided along the width direction of the upper portion of the insertion hole 125c such that the positioning pins 125e and 125e protrude toward the charging region of the photosensitive drum 11 along a longitudinal direction L. As illustrated in FIG. 4, the positioning pins 125e and 125e of the front-end insulating block 125 are fitted into the positioning holes 205a and 205b of the positioning portion 205 provided in the support portion 202 of the front end of the image forming unit 200, thereby performing the positioning of the charging device 12.

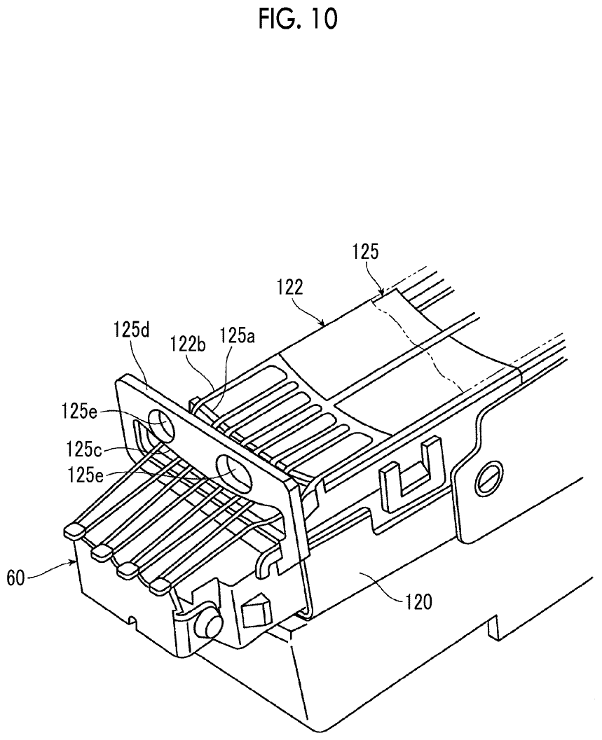

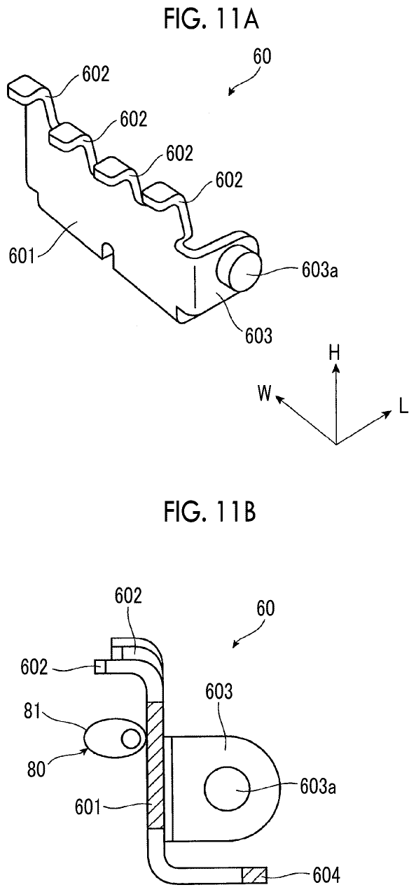

As illustrated in FIGS. 11A and 11B, the tension member 60 provided in the front-end insulating block 125 is formed by performing press working, bending working, or the like on a sheet metal consisting of metal such as stainless steel, or by integral molding of a synthetic resin. The tension member 60 includes a body portion 601 of which a front surface shape is formed to be a horizontally long rectangular shape along the width direction W of the charging device 12, a plurality of locking claw portions 602, 602, and the like provided to protrude upward from the upper end of the body portion 601 at a required interval, shaft support portions 603 and 603 bent to be orthogonal to the body portion 601 from both end portions along the width direction of the body portion 601, and a connection portion 604 that is provided at the lower end portion of the body portion 601 to be bent in the same direction as the shaft support portions 603 and 603 and connects one end of a coil spring 605 as an example of a biasing unit.

As illustrated in FIG. 11A, regarding the locking claw portions 602, 602, and the like of the tension member 60, the locking claw portions 602 and 602 at both end portions along the width direction are disposed at positions close to the grid electrode 122 such that the distances from the respective connection pieces 122b′ and 122b″ of the connection portion 122b of the grid electrode 122 disposed in a curved shape are substantially equal to each other.

The shaft support portions 603 and 603 of the tension member 60 are provided such that the rotation axes 603a and 603a protrude toward both end portions along the width direction. As illustrated in FIG. 12, the rotation axes 603a and 603a of the tension member 60 are rotatably supported by a shaft support portion 125f provided inside the front-end insulating block 125.

As illustrated in FIG. 12, one end of the coil spring 605 is connected to the connection portion 604 of the tension member 60. The other end of the coil spring 605 is fixed inside the insulating block 125. As a result, the tension member 60 is biased along a counterclockwise direction in the drawing. Tension is applied to the grid electrode 122 locked to the locking claw portions 602, 602, and the like of the tension member 60, by the coil spring 605.

The mounting member 127 of the charging device 12 is a member for mounting the charging device 12 in a fixed state in a case where the charging device 12 is mounted on the image forming apparatus 1. As illustrated in FIG. 12, a fixing arm 127a biased along the counterclockwise direction by a spring 127b is rotatably attached to the mounting member 127. The mounted state of the charging device 12 with respect to the image forming apparatus 1 is released by manually gripping a release lever (not illustrated) provided in the mounting member 127 and rotating the fixing arm 127a along a clockwise direction.

### Configuration of Cleaning Device of Charging Device

The charging device 12 according to the first exemplary embodiment includes the cleaning device 70 as an example of a cleaning unit that cleans at least the control electrode of the discharge electrode and the control electrode. The cleaning device 70 according to the first exemplary embodiment cleans both the two discharge wires 121 and the grid electrode 122.

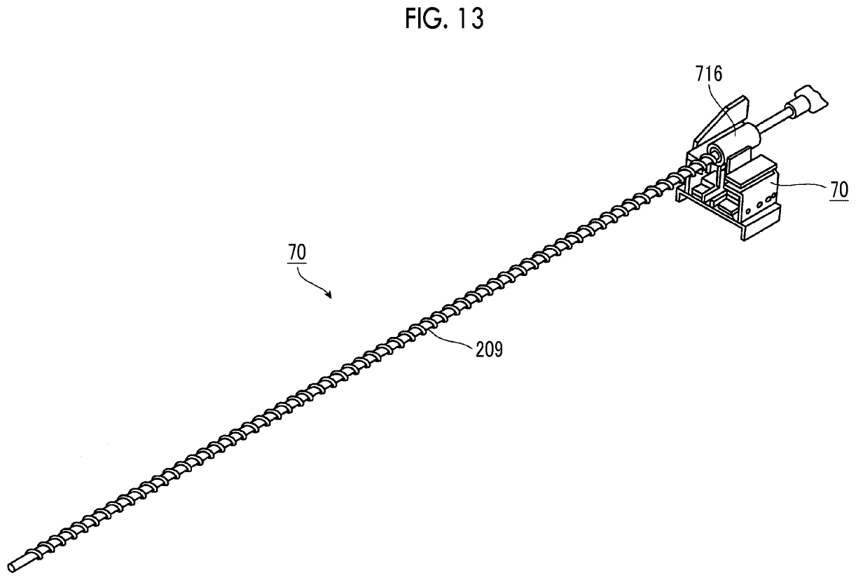

As illustrated in FIG. 13, the cleaning device 70 waits at a standby position set at the end portion on the rear-end insulating block 126 side as one end portion of the shield case 120 of the charging device 12 along the longitudinal direction during the charging by the charging device 12.

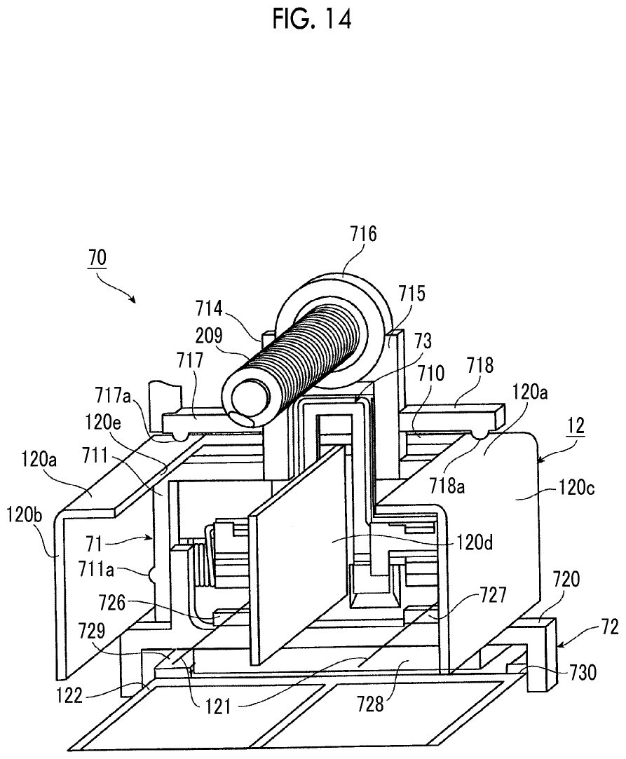

FIG. 14 is a perspective configuration diagram of the elongated charging device 12 on which the cleaning device 70 is mounted, as viewed from the front end side to the rear end side along the longitudinal direction. Note that FIG. 14 illustrates a state where the grid electrode 122 is deformed into a planar shape during cleaning.

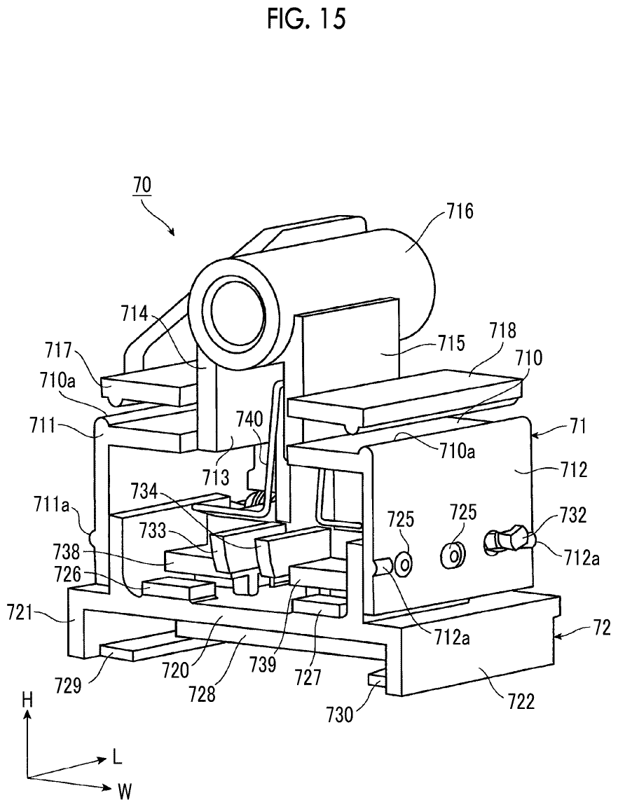

As illustrated in FIG. 15, the cleaning device 70 includes an upper body 71 and a lower body 72. The upper body 71 is formed in a frame shape of which a lower end surface is open and which has a downwardly facing rectangular cross section. The lower body 72 is formed in a frame shape of which the height is lower than the upper body 71 and a lower end surface is open and which has a downwardly facing rectangular cross section. The lower body 72 is integrally provided in a state of being fitted to the lower end portion of the upper body 71.

As illustrated in FIG. 14, the upper body 71 has an upper end portion 710 corresponding to the ceiling wall 120a of the shield case 120, and left and right side surface portions 711 and 712 corresponding to the left and right side walls 120b and 120c of the shield case 120. A guide convex ridge 710a that guides the ceiling wall 120a of the shield case 120 is provided on both ends of the upper end portion 710 of the upper body 71 along the width direction. In addition, the left and right side surface portions 711 and 712 of the upper body 71 are provided with short guide convex ridges 711a and 712a that guide the left and right side walls 120b and 120c of the shield case 120, respectively, at both end portions of the lower portion thereof along the longitudinal direction.

As illustrated in FIG. 15, the upper end portion 710 of the upper body 71 is provided with left and right support plate portions 714 and 715 that protrude upward to face each other to be in parallel with each other via a gap portion 713 at the center along the width direction, and a cylindrical drive portion 716 that is disposed on the upper portions of the left and right support plate portions 714 and 715 along the horizontal direction. A helical groove (not illustrated) that meshes with a helical convex portion 209a of the drive shaft 209 is formed inside the drive portion 716. As illustrated in FIG. 14, the left and right support plate portions 714 and 715 protrude to the upper portion of the ceiling wall 120a via the blowing port 120e opened in the ceiling wall 120a of the shield case 120.

As illustrated in FIG. 15, on the outer surfaces of the left and right support plate portions 714 and 715 of the upper body 71, left and right guide plate portions 717 and 718 are provided to protrude outward along the horizontal direction. On the lower surfaces of the distal ends of the left and right guide plate portions 717 and 718, guide convex ridges 717a and 718a that guide the ceiling wall 120a of the shield case 120 are provided, respectively.

A swing arm 73 that holds the cleaning member is accommodated in the upper body 71. The swing arm 73 is swingably attached to the left and right side surface portions 711 and 712 of the upper body 71 via the rotation axes 731 and 732.

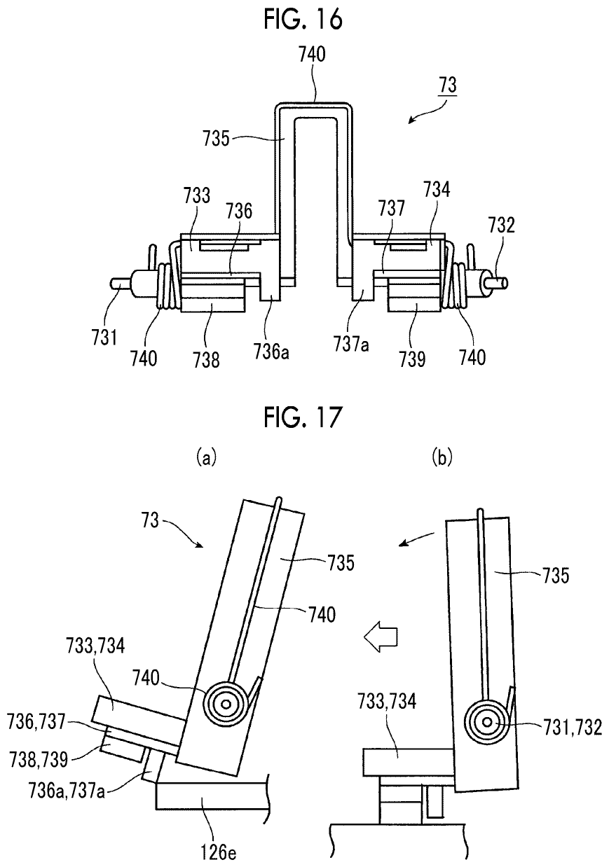

As illustrated in FIGS. 16 to 17, the swing arm 73 integrally includes left and right horizontal plate portions 733 and 734, a connection plate portion 735, and left and right mounting plate portions 736 and 737. The left and right horizontal plate portions 733 and 734 of the swing arm 73 are disposed to be divided into left and right along the horizontal direction across the partition wall 120d of the shield case 120. The distal ends of the left and right horizontal plate portions 733 and 734 along the horizontal direction are provided with rotation axes 731 and 732 that swingably support the swing arms 73. As described above, the rotation axes 731 and 732 of the swing arm 73 are rotatably supported by the insertion holes provided in the left and right side surface portions 711 and 712 of the upper body 71.

The connection plate portion 735 of the swing arm 73 is configured as an elongated downward rectangular frame from the central end along the width direction of the left and right horizontal plate portions 733 and 734 to the upper side along the vertical direction. As illustrated in FIG. 14, the connection plate portion 735 of the swing arm 73 connects the left and right horizontal plate portions 733 and 734 in a state of being across the partition wall 120d of the shield case 120.

The mounting plate portions 736 and 737 of the swing arm 73 are provided to extend along the horizontal direction from the central ends of the left and right horizontal plate portions 733 and 734 along the width direction. To the mounting plate portions 736 and 737 of the swing arm 73, cleaning pads 738 and 739 as an example of the cleaning member that cleans the two discharge wires 121 and 121 from above are attached. The cleaning pads 738 and 739 are formed of members such as felt and sponge.

In facing lower end portions of the connection plate portion 735 of the swing arm 73, operation portions 736a and 737a are provided to protrude downward. The swing arm 73 is wound around the outer peripheries of the rotation axes 731 and 732 and is biased in the counterclockwise direction by a coil spring 740 which is integrally formed on the left and right sides by being tensioned along the outer periphery of the connection plate portion 735. In the coil spring 740, a distal end portion on a side wound around the outer peripheries of the rotation axes 731 and 732 generates a biasing force in the counterclockwise direction by abutting against a part of the upper body 71. Accordingly, the swing arm 73 is rotated in the counterclockwise direction by the biasing force of the coil spring 740 during cleaning, the cleaning pads 738 and 739 are pressed against the cleaning pads provided on the lower body 72, and thereby the two discharge wires 121 and 121 can be cleaned.

On the other hand, as illustrated in FIG. 14, in a state where the cleaning device 70 is positioned at the standby position in a case of not cleaning, the swing arm 73 is stopped in a state where the operation portions 736a and 737a provided at the lower end portions of the mounting plate portions 736 and 737 are pressed by the operation arms provided in the rear-end insulating block 126 to be rotated in the clockwise direction. Therefore, the swing arm 73 is in a state of being rotated in the clockwise direction against the biasing force of the coil spring 740, and the cleaning pads 738 and 739 are separated from the two discharge wires 121 and 121. In this case, the cleaning pad provided on the lower body 72 is also in a state of being separated from the two discharge wires 121 and 121.

The lower body 72 has an upper end surface 720 which is disposed at the lower end portion of the upper body 71 and of which the width is greater than the upper body 71, and left and right side surfaces 721 and 722 provided downward from both end portions of the upper end surface 720 along the width direction.

The upper end surface 720 of the lower body 72 is provided with left and right vertical plate portions 723 and 724 that protrude upward along the vertical direction near both ends along the width direction. In the left and right vertical plate portions 723 and 724 of the lower body 72, two protrusion portions 725 and 725 for fitting and fixing the upper body 71 to the outer surface of the left and right vertical plate portions 723 and 724 are provided along the longitudinal direction. The protrusion portions 725 and 725 of the left and right vertical plate portions 723 and 724 are fitted into and fixed to the insertion holes provided in the left and right side surface portions 711 and 712 of the upper body 71 (refer to FIG. 15).

In the upper end surface 720 of the lower body 72, cleaning pads 726 and 727 are provided at positions facing the cleaning pads 738 and 739 of the upper body 71, respectively, in a fixed state. The cleaning pads 726 and 727 of the lower body 72 are disposed to be slightly separated from the two discharge wires 121 and 121. In addition, a wide cleaning pad 728 that cleans the grid electrode 122 is provided on the lower surface of the upper end surface 720 of the lower body 72. The cleaning pad 728 is formed of a member such as felt or sponge.

In the inner side surfaces of the lower end portions of the left and right side surfaces 721 and 722 of the lower body 72, support plate portions 729 and 730 that support both end portions of the grid electrode 122 along the width direction during cleaning are provided to face each other toward the inner side along the width direction. The upper end surfaces of the support plate portions 729 and 730 are formed in a planar shape.

Incidentally, in the charging device 12 configured as described above, the grid electrode 122 is disposed in a state of being curved in an arc shape along the surface shape of the photosensitive drum 11. Therefore, in a case where the grid electrode 122 of the charging device 12 is cleaned by the cleaning pad 728 of the cleaning device 70, it is difficult for the grid electrode 122 to be pressed by the cleaning pad 728 to come into contact with the surface of the photosensitive drum 11 or difficult to uniformly bring the cleaning pad 728 into contact with the entire surface of the grid electrode 122 disposed in a curved shape, and there is a technical problem in that the cleanability is reduced so that the charging potential of the photosensitive drum 11 varies due to uneven contamination or the like of the grid electrode 122.

Therefore, the charging device according to the first exemplary embodiment is configured to include a deformation unit that, during the cleaning by the cleaning unit, deforms the shape of the control electrode into a shape different from the shape during the charging.

In addition, the charging device according to the first exemplary embodiment is configured such that the control electrode is tensioned in a state where the tension is applied along a direction intersecting the rotation direction of the charged body, and is held in a curved or bent shape along the surface shape of the charged body, by the holding member.

In addition, the charging device according to the first exemplary embodiment is configured such that, during the cleaning, the deformation unit deforms the control electrode into a shape different from the shape during the charging by reducing the tension of the control electrode.

Furthermore, the charging device according to the first exemplary embodiment is configured such that at least one end portion of the control electrode along a direction intersecting the rotation direction of the charged body is biased outward with respect to the charging region of the charged body, by the tension member.

In addition, the charging device according to the first exemplary embodiment is configured such that the deformation unit deforms the control electrode into a shape different from the shape during the charging by changing the position at which the tension member tensions the other end portion of the control electrode inward with respect to the charging region of the charged body along a direction intersecting the rotation direction of the charged body.

That is, as illustrated in FIG. 10, the charging device 12 according to the first exemplary embodiment includes the tension member 60 that constitutes a part of the deformation unit that applies tension to the connection portion 122b positioned at one end portion along the longitudinal direction L of the grid electrode 122.

As illustrated in FIG. 11B, an eccentric cam 80 as an example of the deformation unit is disposed in the tension member 60. The eccentric cam 80 is rotationally driven by rotating a small drive motor (not illustrated) provided in the charging device 12 or by rotating an operation lever (not illustrated) provided in the mounting member 127. Note that the eccentric cam 80 may be configured such that a driving force is transmitted from the image forming unit 200 side. In a case where an eccentric portion 81 of the eccentric cam 80 is rotationally driven to abut against the body portion 601 of the tension member 60, the body portion 601 rotates the tension member 60 along the clockwise direction about the rotation axis 603a against the biasing force of the coil spring 605.

Then, the tension position where the grid electrode 122, which is locked to the locking claw portions 602, 602, and the like of the tension member 60, is tensioned by the front-end insulating block 125 is changed to the charging region along the longitudinal direction L of the charging device 12, and thus the tension of the grid electrodes 122 is released or reduced. Therefore, as illustrated in FIG. 5, the grid electrode 122 is deformed into a flat plate shape by the elastic restoring force of the grid electrode 122.

### Action of Charging Device

In the charging device according to the first exemplary embodiment, in the following manner, the cleanability of the control electrode may be improved while avoiding contact of the control electrode with the surface of the charged body, as compared with a case where the control electrode is cleaned in the same shape as the shape during the charging.

In the image forming apparatus 1, as illustrated in FIG. 1, a cleaning operation of cleaning the discharge wires 121 and 121 and the grid electrode 122 of the charging device 12 by the cleaning device 70 is executed at predetermined timings in accordance with the cumulative image forming time in the respective image creating devices 10 (Y, M, C, K) of yellow (Y), magenta (M), cyan (C), and black (K), the cumulative number of printed sheets of the recording sheet 5, and the like.

In the charging device 12, during the cleaning, an operation of deforming the shape of the grid electrode 122 into a flat plate shape, which is an example of a shape different from the shape during the charging, is executed before the cleaning operation by the cleaning device 70.

As illustrated in FIG. 18, the charging device 12 is rotated along the clockwise direction by operating the eccentric cam 80 with a drive motor or a solenoid (not illustrated), or the release lever provided in the mounting member. Then, the body portion 601 of the tension member 60 is pushed by the eccentric portion 81 of the eccentric cam 80, and is rotated by a predetermined amount along the clockwise direction about the rotation axis 603a.

Therefore, as illustrated in FIG. 19, the plurality of locking claw portions 602, 602, and the like provided at the upper end portion of the tension member 60 are moved toward the charging region side along the longitudinal direction of the charging device 12 with the rotation of the tension member 60, and the tension applied to the grid electrode 122 is released or reduced. Therefore, the grid electrode 122 returns to the flat plate shape that is an original shape, by the elastic restoring force of the grid electrode 122.

Next, as illustrated in FIG. 13, in the cleaning device 70, the drive shaft 209 is rotationally driven so that the drive portion 716 of the cleaning device 70 that meshes with the drive shaft 209 is gradually moved from the rear-end insulating block 126 side toward the front-end insulating block 125 side along the longitudinal direction of the charging device 12.

In a case where the cleaning device 70 is separated from the rear-end insulating block 126, as illustrated in parts (a) and (b) of FIG. 17, a pushing operation of causing the operation arm 126e of the rear-end insulating block 126 to push the operation portions 736a and 737a of the swing arm 73 of the cleaning device 70 is released, the swing arm 73 is rotated in the counterclockwise direction by the biasing force of the coil spring 740, and the cleaning pads 738 and 739 abut against the cleaning pads 726 and 727 of the lower body 72 while pressing the two discharge wires 121 and 121 from the upper portion.

With this configuration, the two discharge wires 121 and 121 of the charging device 12 are sandwiched by the cleaning pads 738 and 739 and the cleaning pads 726 and 727 disposed above and below the cleaning device 70, respectively, and the two discharge wires 121 and 121 are cleaned over the entire length as the cleaning device 70 is moved along the longitudinal direction L of the charging device 12.

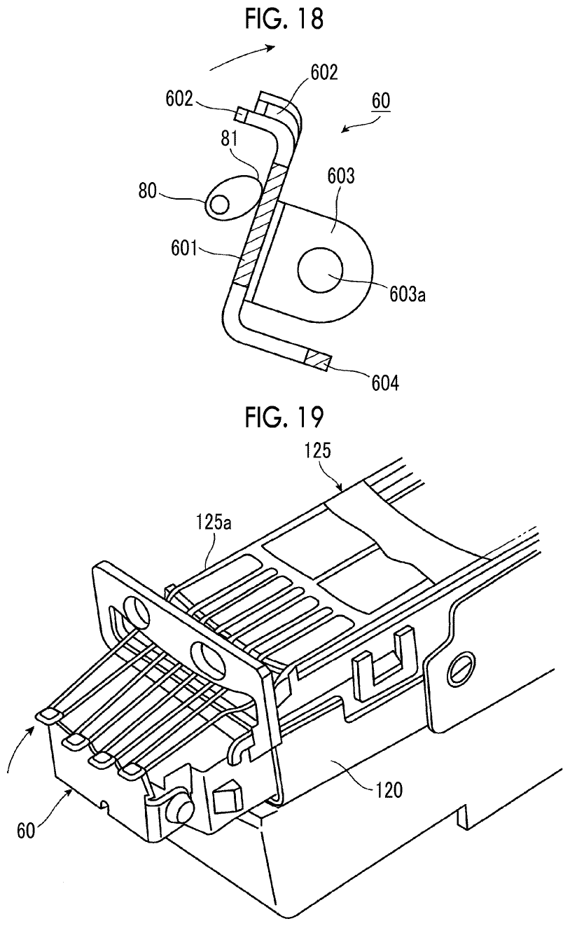

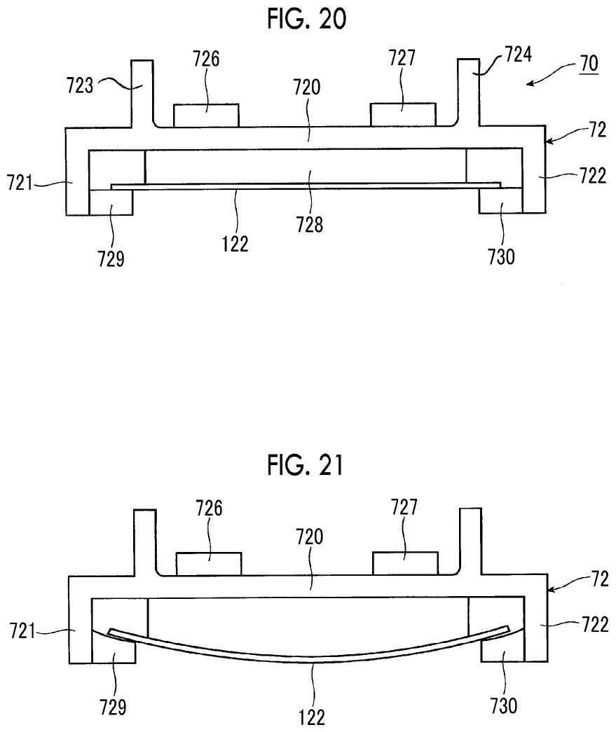

In addition, as illustrated in FIG. 20, the cleaning device 70 cleans the grid electrode 122 with the cleaning pad 728 provided in the lower body 72. The lower surfaces (surfaces on the photosensitive drum 11 side) of both end portions of the grid electrode 122 along the width direction are supported by the support plate portion of the lower body 72. In this case, as compared with a case where the grid electrode 122 is cleaned while maintaining the curved shape, since the grid electrode 122 is deformed into a planar shape, the entire surface of the grid electrode 122 may be cleaned by bringing the cleaning pad 728 into contact with the grid electrode 122, and the cleanability of the grid electrode 122 is improved so that the grid electrode 122 may be satisfactorily cleaned. Therefore, it is possible to prevent or suppress the occurrence of charging unevenness or the like by the charging device 12 due to a decrease in the cleanability of the grid electrode 122 and a decrease in the performance of the grid electrode 122.

In a case where the cleaning device 70 is moved to the front-end insulating block 125 of the charging device 12 and the cleaning operation for the discharge wires 121 and 121 and the grid electrode 122 is ended, the drive shaft 209 is rotationally driven in a reverse direction to cause the cleaning device 70 to return to the standby position, and the series of cleaning operations is ended. Note that the cleaning device 70 can satisfactorily clean the discharge wires 121 and 121 and the grid electrode 122 by being moved a plurality of times along the longitudinal direction L of the charging device 12 in a reciprocation manner.

Note that, as illustrated in FIG. 21, the cleaning device 70 may be configured such that the grid electrode 122 is slightly curved downwardly in a convex shape instead of being simply in a flat plate shape, by modifying the surface shape of the cleaning pad 728 provided in the lower body 72 and the shapes of the support plate portions 729 and 730 that support both end portions of the grid electrode 122 along the width direction. In this case, since the tension of the grid electrode 122 is released or reduced, the grid electrode 122 may be easily, reliably, and slightly curved downwardly in a convex shape.

In a case where the cleaning device 70 is moved to the standby position, the cleaning pads 738 and 739 and the cleaning pads 726 and 727 are separated from the two discharge wires 121 and 121, and the cleaning pad 728 is separated from the grid electrode 122.

### Second Exemplary Embodiment

FIG. 22 is a configuration diagram illustrating a charging device according to a second exemplary embodiment of the present invention. The charging device according to the second exemplary embodiment is configured such that the deformation unit deforms the shape of the holding portion that holds the control electrode, from a curved or bent shape into a planar shape.

In addition, in the second exemplary embodiment, the deformation unit has a holding member that holds one end portion of the control electrode along a direction intersecting the rotation direction of the charged body, the holding member includes a curved surface portion that causes the control electrode to be curved or bent along the surface shape of the charged body during the charging, and a planar portion that, during the cleaning, deforms the shape of the control electrode into a planar shape different from the shape during the charging.

That is, as illustrated in FIG. 22, in the charging device 12 according to the second exemplary embodiment, the holding portion provided in the front-end insulating block 125 that holds one end portion along the longitudinal direction L of the grid electrode 122 is configured as a holding member 130 as an example of the deformation unit, different from the insulating block 125.

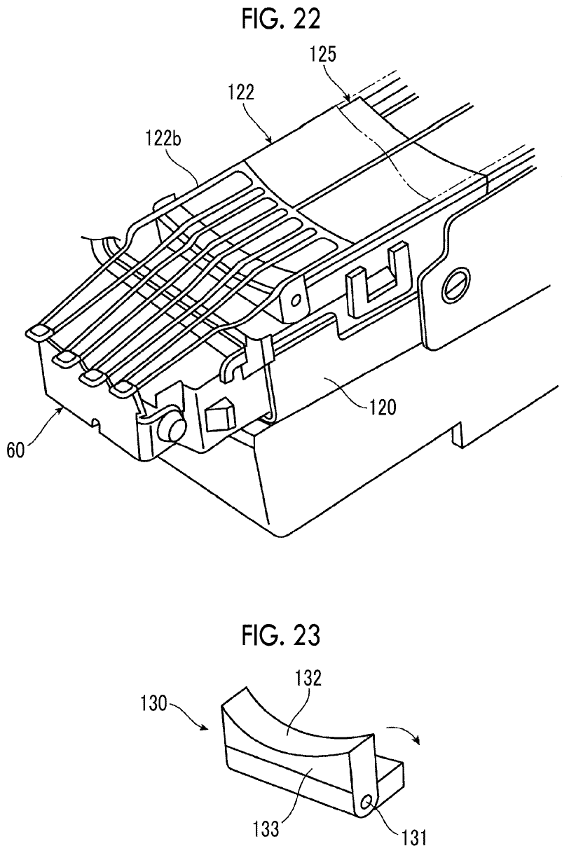

As illustrated in FIG. 23, the holding member 130 is attached to the insulating block 125 to be rotatable about a rotation axis 131 disposed along the width direction W of the grid electrode 122. The holding member 130 is rotationally driven by a drive motor or a solenoid provided in the charging device 12 or by a pinion gear that meshes with a rack gear disposed along the longitudinal direction of the charging device 12 and that is movable along the longitudinal direction by an operation unit provided in the mounting member 127.

The holding member 130 includes a curved surface portion 132 that conforms to the curved shape of the grid electrode 122 provided on the upper end surface of the holding member 130, and a planar portion 133 that is provided on a surface adjacent to the curved surface portion 132. The planar portion 133 of the holding member 130 is set to have the same or smaller protrusion amount from the surface of the insulating block 125 as the protrusion amount of the curved surface portion 132. In a case where the holding member 130 is rotated about the rotation axis 131 and the planar portion 133 comes into contact with the grid electrode 122, the grid electrode 122 is deformed into a planar shape and held.

The holding member 130 may be provided only in the front-end insulating block 125 or may be provided in both the front-end and rear-end insulating blocks 125 and 126.

In the charging device 12 according to the second exemplary embodiment, as illustrated in FIG. 24, during the cleaning, the grid electrode 122 can be deformed into a flat plate shape conforming to the planar portion 133 of the holding member 130 by the planar portion 133 of the holding member 130 being rotated to hold the grid electrode 122.

Therefore, the cleaning device 70 that cleans the charging device 12 can satisfactorily and clean the grid electrode 122 without unevenness by cleaning the grid electrode 122 deformed into a flat plate shape.

Since other configurations and actions are similar to the configurations and actions in the first exemplary embodiment, the description thereof will be omitted.

### Third Exemplary Embodiment

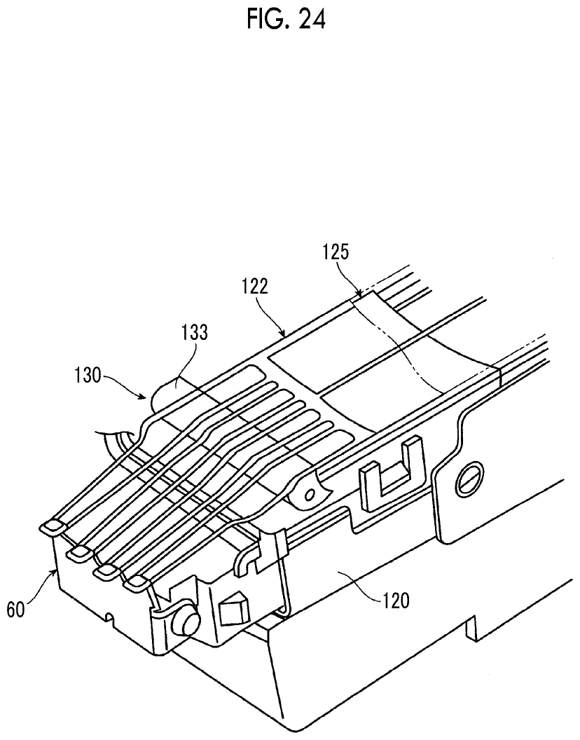

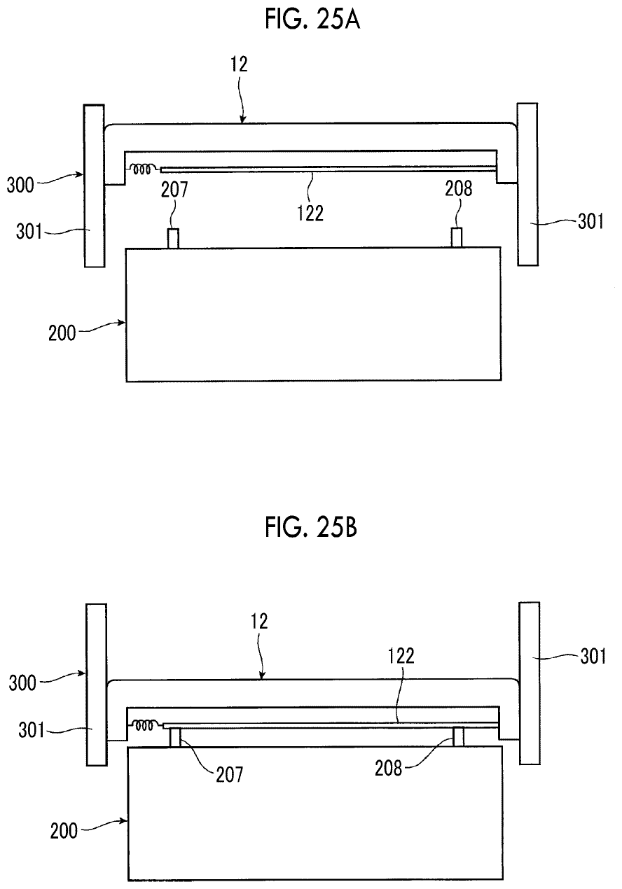

FIGS. 25A and 25B are configuration diagrams illustrating a charging device according to a third exemplary embodiment of the present invention. The charging device according to the third exemplary embodiment is configured such that, during the charging, the control electrode is in a curved shape along the surface shape of the charged body by being pressed against a regulation member provided on the charged body side.

In addition, the charging device according to the third exemplary embodiment is configured such that the deformation unit deforms the shape of the control electrode into a shape different from the shape during the charging, by changing the position of the charging device in a direction of being separated from the charged body.

That is, as illustrated in FIGS. 25A and 25B, the charging device 12 according to the third exemplary embodiment includes a retract mechanism 300 as an example of the deformation unit. The charging device 12 is configured to be movable between a charging position close to the photosensitive drum 11 and a cleaning position separated from the photosensitive drum 11, by the retract mechanism 300 including a guide rail 301.

In the charging device 12, unlike the exemplary embodiment, the grid electrode 122 is tensioned in a planar shape. However, in the charging device 12 according to the third exemplary embodiment, the grid electrode 122 is not limited to being tensioned in a planar shape, and the deformation unit that deforms the grid electrode 122 from a curved shape into a planar shape as in the first exemplary embodiment may be provided. In this case, the charging device 12 is configured to execute the following operation after the grid electrode 122 is deformed from a curved shape into a planar shape.

The charging device 12 is positioned at the charging position close to the photosensitive drum 11 by the retract mechanism during the charging. In this case, as illustrated in FIG. 25B, the grid electrode 122 of the charging device 12 is in a state of being deformed into a curved surface shape conforming to the surface shape of the photosensitive drum 11 by being pressed by the curved portions 207 and 208 provided in the image forming unit 200.

Note that, in FIG. 25B, the grid electrode 122 is illustrated to have a wide width along a thickness direction in order to indicate the grid electrode 122 deformed into a curved surface shape.

On the other hand, during the cleaning, the charging device 12 is moved to the cleaning position separated from the photosensitive drum 11 by the retract mechanism. In a case where the charging device 12 is moved to the cleaning position, the grid electrode 122 of the charging device 12 returns from a curved shape along the surface shape of the photosensitive drum 11 to a planar shape as the original shape, by being separated from the curved portions 207 and 208 of the image forming unit 200.

Then, the charging device 12 performs cleaning for the discharge wires and the grid electrode 122 by using the cleaning device 70 in a state where the grid electrode 122 is deformed into a planar shape.

Note that, in the charging device 12 according to the third exemplary embodiment, the case where the free shape of the grid electrode 122 is a planar shape and the grid electrode 122 is deformed into the curved shape during the charging by both end portions of the grid electrode 122 along the longitudinal direction L being pressed against the curved portions 207 and 208 of the image forming unit 200 has been described.

However, the charging device 12 according to the third exemplary embodiment is not limited thereto, and the charging device 12 may be configured such that the grid electrode 122 is disposed in a curved shape in the charging device 12, and the grid electrode 122 is deformed into a planar shape during the cleaning by pressing the grid electrode 122 with a pressing member (not illustrated) that is provided on the image forming unit 200 side and a distal end of which is formed in a flat plate shape, for example.

In addition, the charging device 12 may be configured to be separated from the photosensitive drum 11 at any time before or after the grid electrode 122 is deformed.

Since other configurations and actions are similar to the configurations and actions in the first exemplary embodiment, the description thereof will be omitted.

### Fourth Exemplary Embodiment

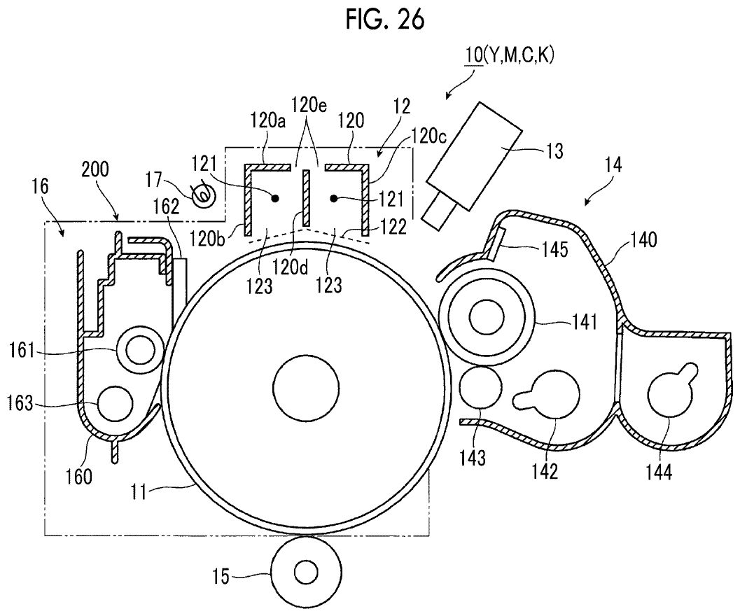

FIG. 26 is a configuration diagram illustrating a charging device according to a fourth exemplary embodiment of the present invention. The charging device according to the fourth exemplary embodiment is configured such that the control electrode is to be in a bent shape instead of a curved shape along the surface shape of the charged body.

That is, as illustrated in FIG. 26, in the charging device 12 according to the fourth exemplary embodiment, the grid electrode 122 is disposed in a shape that is bent into a substantially V-shape or the like along the surface shape of the photosensitive drum 11.

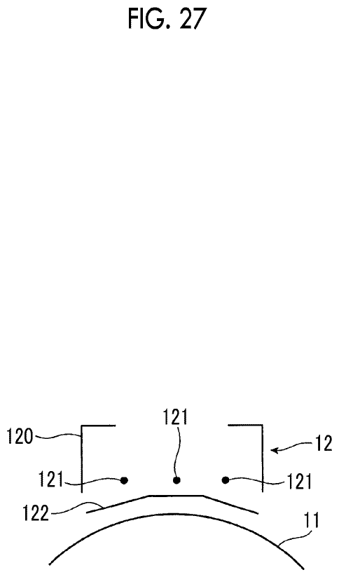

The grid electrode 122 in the flat plate shape may be used by being bent into a substantially V-shape or the like, but a plurality of grid electrodes 122 in the flat plate shape are combined and disposed in a bent shape along the surface shape of the photosensitive drum 11. Note that the shape of the grid electrode 122 is not limited to the shape bent in a substantially V-shape, and as illustrated in FIG. 27, the grid electrode 122 may be disposed in a polyhedral shape in a case where the charging device 12 has three discharge wires 121.

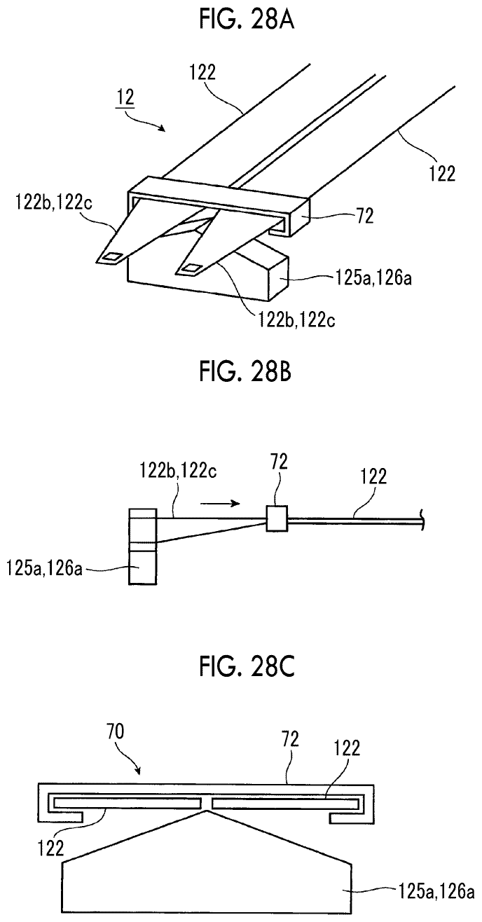

As illustrated in FIGS. 28A to 28C, the holding portions 125a and 126a of the insulating blocks 125 and 126 that hold the grid electrode 122 are formed in a shape that is bent in a reverse V-shape or the like instead of a curved shape conforming to the shape of the grid electrode 122.

In a case where the grid electrode 122 is configured by combining two flat plate-shaped grid electrodes 122, as illustrated in FIGS. 28A to 28C, the lower body 72 of the cleaning device 70 which holds the grid electrodes 122 is configured to hold the two grid electrodes 122 in a flat plate shape.

That is, during the cleaning, in a case where the cleaning device 70 is moved from the connection portion 122c positioned at one end portion of the grid electrode 122 to the connection portion 122b, the two grid electrodes 122 disposed in a V-shape are deformed into a flat plate shape by a flat plate-shaped holder member 150 of the cleaning device 70 holding both end portions thereof along the width direction W.

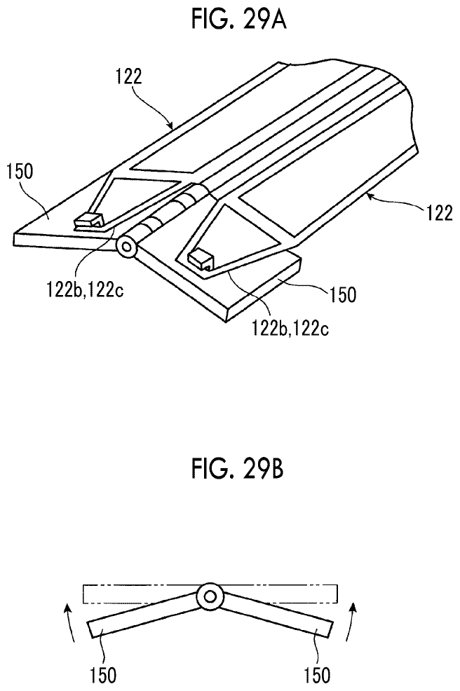

FIGS. 29A and 29B are configuration diagrams illustrating a modified example of the charging device according to the fourth exemplary embodiment.

In the modified example of the charging device 12 according to the fourth exemplary embodiment, as illustrated in FIGS. 29A and 29B, the tension member that tensions both end portions of the two grid electrodes 122 and 122 along the longitudinal direction is configured to be able to be opened and closed in a hinge shape via a central shaft disposed between the two grid electrodes 122.

Then, in the charging device 12, as illustrated in FIGS. 29A and 29B, during the cleaning, the tension member is rotated to tension the two grid electrodes 122 in a flat plate shape, so that the two grid electrodes 122 can be deformed into a flat plate shape and cleaned by the cleaning device 70.

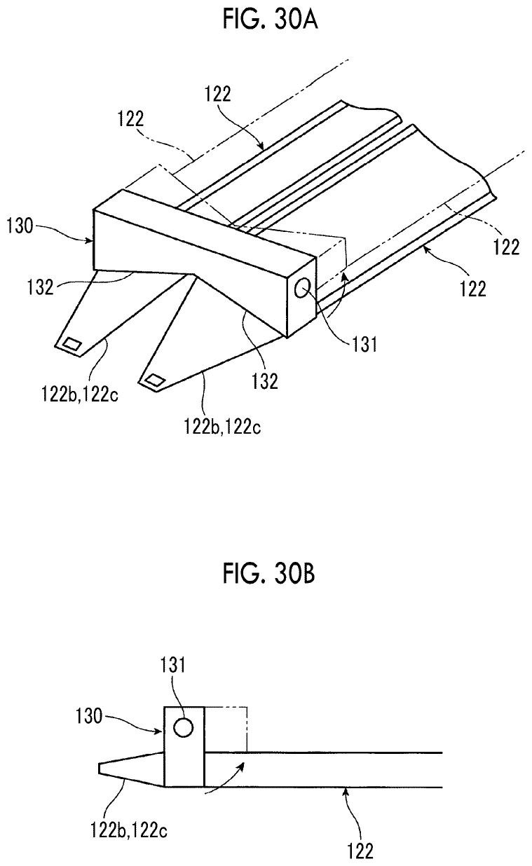

FIGS. 30A and 30B are configuration diagrams illustrating a further modified example of the charging device according to the fourth exemplary embodiment.

In the modified example of the charging device 12, as illustrated in FIGS. 30A and 30B, similar to the second exemplary embodiment, the tension member 60 that tensions the two grid electrodes 122 in a V-shape includes the V-shaped curved surface portion 132 and the planar portion 133.

Then, in the modified example of the charging device 12, during the cleaning, the planar portion 133 of the tension member 60 is rotated to come into contact with the two grid electrodes 122, so that the two grid electrodes 122 are deformed into a flat plate shape.

Since other configurations and actions are similar to the configurations and actions in the first exemplary embodiment, the description thereof will be omitted.

Note that, in the exemplary embodiment, the full-color image forming apparatus has been described. However, it is of course possible to apply the present disclosure to a monochrome image forming apparatus as well.

In addition, in the exemplary embodiment, the case where the number of discharge wires 121 is two has been described, but the number of discharge wires 121 is not limited to two, and one discharge wire 121 or three or more discharge wires 121 may be provided.

### Supplementary Note

(((1)))

A charging device comprising:
a discharge electrode;
a control electrode that is disposed between the discharge electrode and a charged body charged by the discharge electrode, and is curved or bent along a surface shape of the charged body;
a cleaning unit that cleans at least the control electrode of the discharge electrode and the control electrode; and
a deformation unit that deforms a shape of the control electrode into different shapes between during cleaning and during charging by the cleaning unit.
(((2)))

The charging device according to (((1))),
wherein the control electrode is tensioned in a state where tension is applied along a direction intersecting a rotation direction of the charged body, and is held in a curved or bent shape along the surface shape of the charged body by a holding member.
(((3)))

The charging device according to (((2))),
wherein during the cleaning, the deformation unit deforms the shape of the control electrode into a shape different from the shape during the charging by reducing the tension of the control electrode.
(((4)))

The charging device according to (((1))),
wherein at least one end portion of the control electrode along a direction intersecting a rotation direction of the charged body is biased outward with respect to a charging region of the charged body by a tension member.
(((5))

The charging device according to (((4))),
wherein the deformation unit deforms the shape of the control electrode into a shape different from the shape during the charging by changing a position where the tension member tensions the other end portion of the control electrode inward with respect to the charging region of the charged body along the direction intersecting the rotation direction of the charged body.
(((6)))

The charging device according to (((1))),
wherein the deformation unit deforms a shape of a holding portion that holds the control electrode from a curved or bent shape into a planar shape.
(((7)))

The charging device according to (((6))),
wherein the deformation unit includes a holding member that holds one end portion of the control electrode along a direction intersecting a rotation direction of the charged body, and the holding member includes a curved surface portion that causes the control electrode to be curved or bent along the surface shape of the charged body during the charging, and a planar portion that, during the cleaning, deforms the shape of the control electrode into a planar shape different from the shape during the charging.
(((8)))

The charging device according to (((1))),
wherein during the charging, the control electrode is in a curved shape along the surface shape of the charged body by being pressed against a regulation member provided on a charged body side.
(((9)))

The charging device according to (((8))),
wherein the deformation unit deforms the shape of the control electrode into a shape different from the shape during the charging, by changing a position of the charging device in a direction of being separated from the charged body.
(((10)))

The charging device according to (((1))),
wherein the deformation unit deforms the shape of the control electrode into a shape different from the shape during the charging, and changes a position of the charging device in a direction of being separated from the charged body.
(((11)))

The charging device according to (((1))),
wherein the deformation unit deforms the shape of the control electrode into a shape different from the shape during the charging by pressing both end portions of the control electrode along a direction intersecting a rotation direction of the charged body.
(((12)))

The charging device according to (((11))),
wherein the deformation unit includes a pressing member that presses the both end portions of the control electrode along the direction intersecting the rotation direction of the charged body, and
the pressing member includes a pressing portion that deforms the control electrode into a planar shape.
(((13)))

The charging device according to (((1))),
wherein the cleaning unit cleans both the discharge electrode and the control electrode.
(((14)))

The charging device according to (((13))),
wherein the cleaning unit includes a first cleaning member that comes into contact with the discharge electrode, and a second cleaning member that comes into contact with both front and back surfaces of the control electrode deformed into a shape different from the shape during the charging.
(((15)))

An image forming unit that is attached to and detached from an image forming apparatus, the image forming unit comprising:
the charging device according to any one of (((1))) to (((14))).
(((16)))

An image forming apparatus comprising:
an image holding unit;
a charging unit that charges a surface of the image holding unit; and
an electrostatic latent image forming unit that forms an electrostatic latent image on the surface of the image holding unit charged by the charging unit,
wherein the charging device according to any one of (((1))) to (((14))) is used as the charging unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a discharge electrode;
a control electrode that is disposed between the discharge electrode and a charged body charged by the discharge electrode, and is curved or bent along a surface shape of the charged body;
a cleaning unit that cleans at least the control electrode of the discharge electrode and the control electrode; and
a deformation unit that deforms a shape of the control electrode into different shapes between during cleaning and during charging by the cleaning unit.

2. The charging device according to claim 1,
wherein the control electrode is tensioned in a state where tension is applied along a direction intersecting a rotation direction of the charged body, and is held in a curved or bent shape along the surface shape of the charged body by a holding member.

3. The charging device according to claim 2,
wherein during the cleaning, the deformation unit deforms the shape of the control electrode into a shape different from the shape during the charging by reducing the tension of the control electrode.

4. The charging device according to claim 1,
wherein at least one end portion of the control electrode along a direction intersecting a rotation direction of the charged body is biased outward with respect to a charging region of the charged body by a tension member.

5. The charging device according to claim 4,
wherein the deformation unit deforms the shape of the control electrode into a shape different from the shape during the charging by changing a position where the tension member tensions the other end portion of the control electrode inward with respect to the charging region of the charged body along the direction intersecting the rotation direction of the charged body.

6. The charging device according to claim 1,
wherein the deformation unit deforms a shape of a holding portion that holds the control electrode from a curved or bent shape into a planar shape.

7. The charging device according to claim 6,
wherein the deformation unit includes a holding member that holds one end portion of the control electrode along a direction intersecting a rotation direction of the charged body, and
the holding member includes a curved surface portion that causes the control electrode to be curved or bent along the surface shape of the charged body during the charging, and a planar portion that, during the cleaning, deforms the shape of the control electrode into a planar shape different from the shape during the charging.

8. The charging device according to claim 1,
wherein during the charging, the control electrode is in a curved shape along the surface shape of the charged body by being pressed against a regulation member provided on a charged body side.

9. The charging device according to claim 8,
wherein the deformation unit deforms the shape of the control electrode into a shape different from the shape during the charging, by changing a position of the charging device in a direction of being separated from the charged body.

10. The charging device according to claim 1,
wherein the deformation unit deforms the shape of the control electrode into a shape different from the shape during the charging, and changes a position of the charging device in a direction of being separated from the charged body.

11. The charging device according to claim 1,
wherein the deformation unit deforms the shape of the control electrode into a shape different from the shape during the charging by pressing both end portions of the control electrode along a direction intersecting a rotation direction of the charged body.

12. The charging device according to claim 11,
wherein the deformation unit includes a pressing member that presses the both end portions of the control electrode along the direction intersecting the rotation direction of the charged body, and
the pressing member includes a pressing portion that deforms the control electrode into a planar shape.

13. The charging device according to claim 1,
wherein the cleaning unit cleans both the discharge electrode and the control electrode.

14. The charging device according to claim 13,
wherein the cleaning unit includes a first cleaning member that comes into contact with the discharge electrode, and a second cleaning member that comes into contact with both front and back surfaces of the control electrode deformed into a shape different from the shape during the charging.

15. An image forming unit that is attached to and detached from an image forming apparatus, the image forming unit comprising:
the charging device according to claim 1.

16. An image forming unit that is attached to and detached from an image forming apparatus, the image forming unit comprising:
the charging device according to claim 2.

17. An image forming unit that is attached to and detached from an image forming apparatus, the image forming unit comprising:
the charging device according to claim 3.

18. An image forming unit that is attached to and detached from an image forming apparatus, the image forming unit comprising:
the charging device according to claim 4.

19. An image forming unit that is attached to and detached from an image forming apparatus, the image forming unit comprising:
the charging device according to claim 5.

20. An image forming apparatus comprising:
an image holding unit;
a charging unit that charges a surface of the image holding unit; and
an electrostatic latent image forming unit that forms an electrostatic latent image on the surface of the image holding unit charged by the charging unit,
wherein the charging device according to claim 1 is used as the charging unit.
